(19) United States
(12) Patent Application Publication
(10) Pub. No.: US 2021/0037278 A1
(43) Pub. Date: Feb. 4, 2021

(54) SYSTEMS AND METHODS FOR DESIGNING AND GENERATING A DISTRIBUTED MANIFESTATION

(71) Applicant: ESKI Inc., Montreal (CA)

(72) Inventors: Vincent Leclerc, Montreal (CA); Jean-Sébastien Rousseau, Pointe-Claire (CA); Vadim Kravtchenko, Montreal (CA); Raymel Alfonso Sallo, Saint-Eustache (CA)

(73) Assignee: ESKI Inc., Montreal (CA)

(21) Appl. No.: 17/076,625

(22) Filed: Oct. 21, 2020

Related U.S. Application Data
(63) Continuation of application No. PCT/CA2019/050653, filed on May 15, 2019.
(60) Provisional application No. 62/671,689, filed on May 15, 2018.

(51) Int. Cl. H04N 21/41; H04N 21/4363; G06F 3/0484; G06F 1/16

(52) U.S. Cl. CPC H04N 21/4122; G06F 1/163; G06F 3/04847; H04N 21/43637

(57) ABSTRACT

In some embodiments, a tool set may enable a designer to specify how a distributed manifestation will unfold over time within a particular physical space, and view a simulation of processing performed by receiver units in response to receiving electromagnetic signals transmitted by one or more projector units within the space according to user-specified parameters. The tool set may enable a user to specify the locations of and movement by one or more projector units (thus defining how signals are incident upon receiving units); whether or not optics components are used; alter the zoom rate of a projector unit; simulate signal degradation; vary the number of receiving units in areas within the space; and/or otherwise specify how signals will be transmitted. As such, the user may produce more sophisticated, cohesive and visually stunning distributed manifestations than otherwise would have been possible. Control data may be generated for controlling the projector units, enabling a distributed manifestation designed using the tool set to be precisely reproduced.

### RELATED APPLICATIONS

This application is a continuation of commonly assigned International Patent Application No. PCT/CA2019/050653, filed May 15, 2019, entitled “Systems and Methods for Designing and Generating a Distributed Manifestation,” assigned Attorney Docket No. E0499.70011W000, which claims priority to commonly assigned U.S. Provisional Patent Application Ser. No. 62/671,689, filed May 15, 2018, entitled “Systems and Methods for Designing and Generating a Distributed Manifestation,” assigned Attorney Docket No. E0499.70011US00. The entirety of each of the documents listed above is incorporated herein by reference.

### BACKGROUND

Commonly assigned U.S. Pat. No. 8,740,391 (hereinafter “the '391 patent”) discloses systems and methods for creating a distributed manifestation within a physical environment. In some embodiments disclosed in the '391 patent, a projection system, comprising one or more projector units, transmits electromagnetic signals to receiving units distributed throughout the environment. Each projector unit may send the same electromagnetic signals at a given time to all receiving units in range of the projector, and various different receiving units may be pre-programmed in different ways to respond to signals received from a projector unit in a particular manner. For example, a first group of receiving units at one location in the environment may be pre-programmed to process electromagnetic signals received from a projector unit and manifest a first change in state (e.g., by lighting up in a first color), and a second group of receiving units at another location in the environment may be pre-programmed to process the same electromagnetic signals received from a projector unit to manifest a second change in state (e.g., by lighting up in a second color).

### SUMMARY

Commonly assigned U.S. Provisional Patent Application Ser. No. 62/568,383 (hereinafter “the '383 application”), entitled “Localized Illumination With Encoded Data,” also discloses systems and methods for creating a distributed manifestation within a physical environment. In the system disclosed in the '383 application, as in the system disclosed by the '391 patent, a projector unit transmits electromagnetic signals to receiving units in the environment. However, in some embodiments disclosed in the '383 application, a projector unit is capable of projecting electromagnetic signals toward localized areas within the environment, and different projector units may transmit different electromagnetic signals toward different localized areas within the environment. A projector unit may be capable of movement (e.g., by tilting and/or panning from a fixed location, moving freely in space as a result of being transported by an operator, and/or moving in some other fashion). For example, a handheld projector unit may be pointed toward one or more sections of an arena or stadium in which attendees wearing receiving units are located, and transmit electromagnetic signals to the receiving units in the section(s). In some embodiments disclosed in the '383 application, a projector unit may be configured to emit visible light in addition to transmitting electromagnetic signals having wavelengths in the non-visible portions of the spectrum, so that an operator of the projector unit may more easily see where in the environment the electromagnetic signals are being transmitted, and thus transmit with greater precision.

It should be appreciated that a system which includes multiple projector units for transmitting different electromagnetic signals toward different areas in an environment, enabling different groups of receiving units to manifest different changes in state, allows for the creation of sophisticated, dynamic and visually stunning distributed manifestations. It should also be appreciated, however, that planning such a distributed manifestation is a highly complex exercise. Significant coordination is needed to plan the transmissions over time by multiple projector units to produce cohesive and visually satisfying effects. Further, because each physical space in which a distributed manifestation is to take place has its own unique physical characteristics, and will have receiving units laid out differently, creating a distributed manifestation in each space typically requires a separate, typically time-consuming planning exercise. Additionally, designers often seek to synchronize a distributed manifestation with an event occurring in a space at the same time, such as a musical performance or sporting event, which may include accompanying lighting displays. Given the number of projector units potentially transmitting signals independently, in a unique physical space, to receiving units laid out in complex configurations, it can be very difficult for a designer to conceive of a distributed manifestation in the abstract beforehand, let alone orchestrate it as an event takes place, in a manner which is synchronized with the event.

Accordingly, some embodiments of the invention provide a tool set for designing and orchestrating a distributed manifestation. In some embodiments, a tool set enables a designer to specify how a distributed manifestation will unfold over time within a particular physical space, and view a simulation of particular electromagnetic signals being transmitted by one or more projector units to receiver units within the physical space according to one or more specified parameters. In some embodiments, such a tool set may take as input (1) data defining a physical space in which a distributed manifestation is to occur, and (2) information supplied by a designer specifying how and when electromagnetic signals encoded with particular specified commands are transmitted to particular areas at which receiving units reside within the space. The tool set may, for example, enable a user to specify the locations of one or more projector units within the space and the manner in which each projector unit moves over time (and thus how signals are incident upon receiving units in the space over time); whether or not optics components are used by any projector units to create shapes or otherwise affect which receiving units receive signals; alter the zoom and/or focus of each projector unit over time; simulate signal degradation; vary the number of receiving units within particular areas in the space; and/or otherwise specify the manner in which signals are to be transmitted in a space over time. In some embodiments, the tool set may generate a three-dimensional representation of the distributed manifestation, and cause it to be displayed to the designer on a display screen from any of multiple perspectives, so that the designer may modify one or more parameters and visualize the effect of those changes on the distributed manifestation. A tool set implemented in accordance with some embodiments of the invention thus may enable a designer to produce more sophisticated, cohesive and visually stunning distributed manifestations than might have been conceived by the designer in the abstract. A tool set implemented in accordance with some embodiments of the invention may also produce output control data for controlling projector units in the space during the event, enabling a distributed manifestation designed using the tool set to be orchestrated with precision.

The foregoing is intended as a brief, non-limiting overview of only some aspects of the invention. A more detailed description of certain embodiments of the invention is provided in the sections that follow. Some embodiments of the invention are defined in the attached claims.

### BRIEF DESCRIPTION OF DRAWINGS

The accompanying drawings are not intended to be drawn to scale. In the drawings, each identical or nearly identical component illustrated in the various figures is represented by a like numeral. For purposes of clarity, not every component may be labeled in every drawing. In the drawings:

FIG. 1 is a block diagram depicting components of a representative system for designing and generating a distributed manifestation, in accordance with some embodiments of the invention;

FIG. 2 is a block diagram depicting representative inputs received by, and outputs produced by, a tool set implemented in accordance with some embodiments of the invention;

FIG. 3 is a flowchart depicting a representative process for designing and generating a distributed manifestation, in accordance with some embodiments of the invention;

FIGS. 4A-4B depict a representative graphical representation of projector units and zones in an environment, defined using a tool set implemented in accordance with some embodiments of the invention;

FIG. 5 depicts a representative graphical representation of an interface panel through which a user may supply input defining parameters relating to transmissions by one or more projector units, in accordance with some embodiments of the invention;

FIG. 6 depicts a representative graphical representation of an interface panel through which a user may supply input to initiate a simulation of transmissions, in accordance with some embodiments of the invention;

FIG. 7 depicts a representative graphical representation of simulated transmissions by a projector unit, using a tool set implemented in accordance with some embodiments of the invention;

FIGS. 8A-8B depict a representative graphical representation of an interface panel through which a user may supply input to modify a position of a projector unit, in accordance with some embodiments of the invention;

FIG. 9A depicts a representative graphical representation of an interface panel through which a user may supply input to specify display of an area encompassed by transmissions by a projector unit, in accordance with some embodiments of the invention;

FIG. 9B depicts a representative graphical representation of an interface panel through which a user may supply input to specify display of signals transmitted by a projector unit, in accordance with some embodiments of the invention;

FIGS. 10A-10B depict a representative graphical representation of simulated transmissions by a projector unit using an optics component, in accordance with some embodiments of the invention;

FIGS. 11A-11C depict a representative graphical representation of simulated transmissions by a projector unit performing tilt operations specified by a user, in accordance with some embodiments of the invention;

FIGS. 12A-12B depict a representative graphical representation of simulated transmissions by a projector unit performing pan operations specified by a user, in accordance with some embodiments of the invention;

FIG. 12C depicts a representative graphical representation of an obstructed signal warning displayed to a user of a tool set implemented in accordance with some embodiments of the invention;

FIGS. 13A-13B depict a representative graphical representation of simulated transmissions by a projector unit using a zoom rate specified by a user, in accordance with some embodiments of the invention;

FIGS. 14A-14C depict a representative graphical representation of a distributed manifestation created using degraded signal transmissions specified by a user, in accordance with some embodiments of the invention;

FIG. 15 depicts a representative graphical representation of simulated transmissions by multiple projector units as specified by a user, in accordance with some embodiments of the invention;

FIG. 16 depicts a representative graphical representation of a simulated distributed manifestation according to parameters specified by a user, in accordance with some embodiments of the invention;

FIG. 17 depicts a representative graphical representation of control data produced in response to user input, in accordance with some embodiments of the invention; and

FIG. 18 is a block diagram depicting components of a representative computing system with which certain aspects of the invention may be implemented.

### DETAILED DESCRIPTION

Some embodiments of the invention are directed to methods and apparatus for enabling a user to design and orchestrate a distributed manifestation. For example, some embodiments may enable a designer to specify how a distributed manifestation will unfold over time within a particular physical space, and to visualize the result of electromagnetic signals being transmitted by one or more projector units to receiver units within the space according to one or more specified parameters. In some embodiments, a tool set may take, as input, information defining a physical space in which a distributed manifestation is to occur, and specifications from a designer as to how and when electromagnetic signals encoded with particular commands are to be transmitted to particular areas within the space in which groups of receiving units reside. The tool set may, for example, enable a designer to specify the location(s) of one or more projector units within the space, and the manner in which each projector unit moves over time (and thus the angle of incidence of signals transmitted by the projector unit(s) upon receiving units in the space over time), whether or not optics components are used by any of the projector units to create shapes or otherwise affect the receiving units that receive transmitted signals, alter the zoom and/or focus of each projector unit over time, simulate signal degradation, simulate a particular number of receiving units within particular areas in the space, and/or otherwise specify how a distributed manifestation is to occur. Based on this input, the tool set may generate a three-dimensional representation of the distributed manifestation, and cause it to be displayed on a display screen, from any of multiple physical perspectives. Using the graphical representation as a guide, the designer may then iteratively modify one or more transmission parameters, and visualize the effect of those modifications on the distributed manifestation. As such, a user of such a tool set may produce more sophisticated, dynamic and elaborate distributed manifestations than he/she could have conceived in the abstract. In some embodiments of the invention, such a tool set may be configured to generate control data for controlling individual projector units in the space during an event, so as to reproduce the distributed manifestation as it was designed, with precision.

The sections that follow describe a representative system environment, a representative procedure for designing and generating a distributed manifestation, and potential applications for a tool set implemented in accordance with some embodiments of the invention.

### 1. Representative System Environment

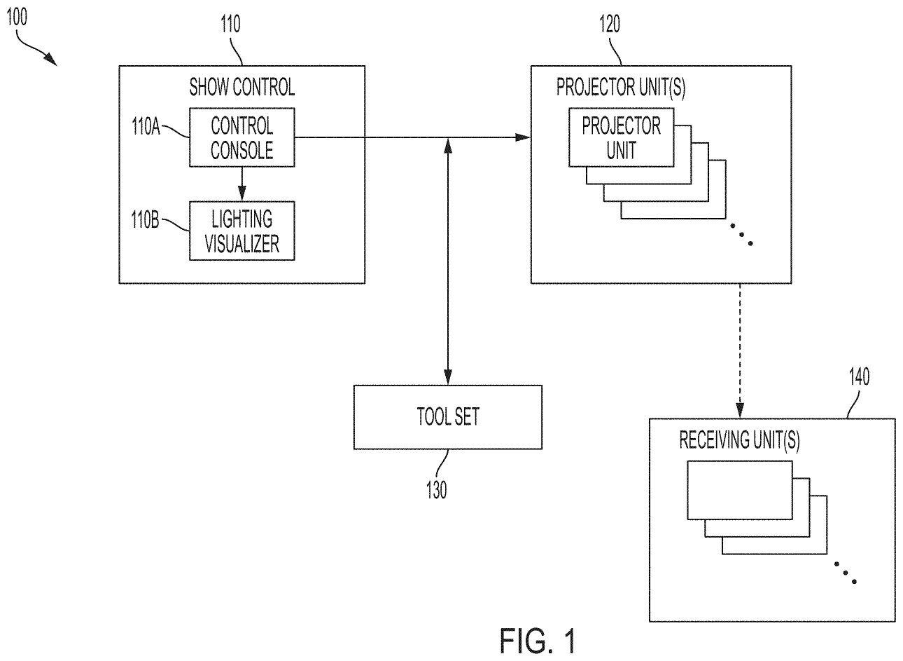

FIG. 1 depicts components of a representative system 100 for designing and generating a distributed manifestation. Representative system 100 includes show control component(s) 110, projector unit(s) 120, tool set 130, and receiving unit(s) 140.

In some embodiments of the invention, show control component(s) 110 comprise one or more tools which are conventionally used to coordinate the emission of visible light by lighting equipment during an event. In representative system 100, show control component(s) 110 include control console 110A, which may be any of numerous consoles conventionally used for this purpose, and lighting visualizer 110B. One example of a conventional control console 110A for coordinating lighting displays is the GRANDMA2 console, and one example of a lighting visualizer 110B is the MA3D lighting visualizer, although any of numerous control consoles and lighting visualizers may be employed.

In representative system 100, tool set 130 receives information from control console 110A relating to the physical space in which a distributed manifestation is to take place, including an identification and position of one or more projector units for transmitting electromagnetic signals within the space. The information relating to the physical space may be provided to tool set 130 in any suitable form. In embodiments which employ the GRANDMA2 control console for coordinating lighting displays, the information may be provided in the known ART-NET format. Of course, the invention is not limited to using information provided in this format, as information on a physical space may be provided in any suitable format(s) to tool set 130, whether now known or later developed. In some embodiments, the information provided by control console 110A which identifies and specifies a position for each projector unit may also identify and specify a position for any lighting fixtures, equipment and/or decorative elements to be used during an event (e.g., lighting, trusses, team flags, speakers, etc.), so that the designer of a distributed manifestation may be aware of the location of these elements, and may specify that transmissions by projector units avoid the physical obstructions that the elements may represent. This is described in further detail below.

It should also be appreciated that information relating to a physical space in which a distributed manifestation is to occur need not be provided by a control console 110A, as it may be provided by any suitable source(s). For example, in some embodiments this information may be provided by an owner or operator of the physical space, or other provider.

In representative system 100, tool set 130 processes the information relating to the physical space, and input from a user relating to transmissions by one or more projector units within the physical space, to generate a three-dimensional graphical representation of a resulting distributed manifestation. As the user supplies this input data, tool set 130 may enable the user to see how his/her specifications affect the distributed manifestation, and modify his/her input, if desired, to change how it unfolds. In this manner, a user may iteratively define aspects of the distributed manifestation, and take advantage of previously successful techniques, if desired. Once the user is satisfied with the distributed manifestation as designed, he/she may instruct tool set 130 to generate control data for controlling the transmission of electromagnetic signals by projector units in the physical space during an event, so as to precisely reproduce the distributed manifestation as it was designed.

The control data produced by tool set 130 may, for example, be merged with corresponding control data produced by control console 110A for controlling lighting equipment during the same event. As such, some embodiments of the invention may allow for highly coordinated displays in which manifestations of changes in state by receiving units may be synchronized with lighting produced by lighting equipment in the space.

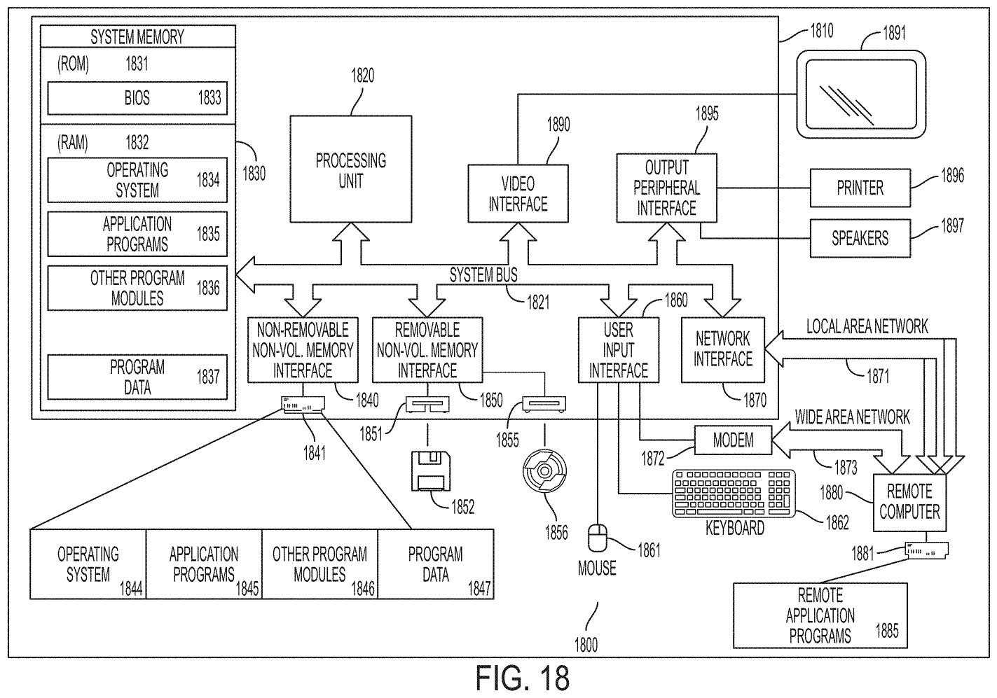

Tool set 130 may be implemented in any of numerous ways. For example, tool set 130 may be implemented using hardware, software or a combination thereof. When implemented in software, software code may be executed on any suitable processor or collection of processors, whether provided in a single computer or distributed among multiple computers. when implemented using dedicated or general-purpose hardware, such hardware may be programmed using microcode or software to perform the functions described herein, and/or other functions. A description of a representative computing system which may be used to implement controller tool set 130 is provided below with reference to FIG. 18.

In representative system 100, projector unit(s) 120 is (are) configured to transmit electromagnetic signals to receiving units 140 within an environment so as to create a distributed manifestation, according to control data generated by tool set 130. Any suitable number and type of projector units may be used for this purpose. For example, the commonly assigned '391 patent referenced above discloses multiple types of projector units for transmitting electromagnetic signals to receiving units 140. The commonly assigned '383 application referenced above also discloses multiple different types of projector units for transmitting electromagnetic signals to receiving units 140. Any suitable number and type(s) of projector unit(s) 120 may be used to transmit electromagnetic signals to receiving unit(s) 140.

In some embodiments, a projector unit 120 may be configured to transmit electromagnetic signals which have wavelengths in the infrared portion of the spectrum, and are encoded with information that, when received by a receiving unit within the environment, is processed by the receiving unit to produce a change in state in the receiving unit, such as a visual effect. In some embodiments, a projector unit 120 may be configured to change position over time, so as to transmit electromagnetic signals toward different locations (e.g., localized areas within an environment) over time. As one example, a projector unit may be affixed to a support structure within the environment, and may pan and/or tilt and zoom in/out to project electromagnetic signals toward different areas in the environment over time. As another example, a projector unit 120 may be transported by an operator (e.g., a handheld projector unit may be operated by a performer during an event), and may project electromagnetic signals toward different localized areas within an environment over time as the operator changes the orientation of the projector unit.

Receiving units 140 may include any suitable number and type of receiving units. Some representative types of receiving units 140 are described in the '391 patent referenced above. For example, a receiving unit 140 may comprise a wristband, badge, pendant, and/or any other suitable implement. In some embodiments, a receiving unit 140 may be adapted to be worn or otherwise transported by an attendee at an event, although the invention is not limited to such an implementation.

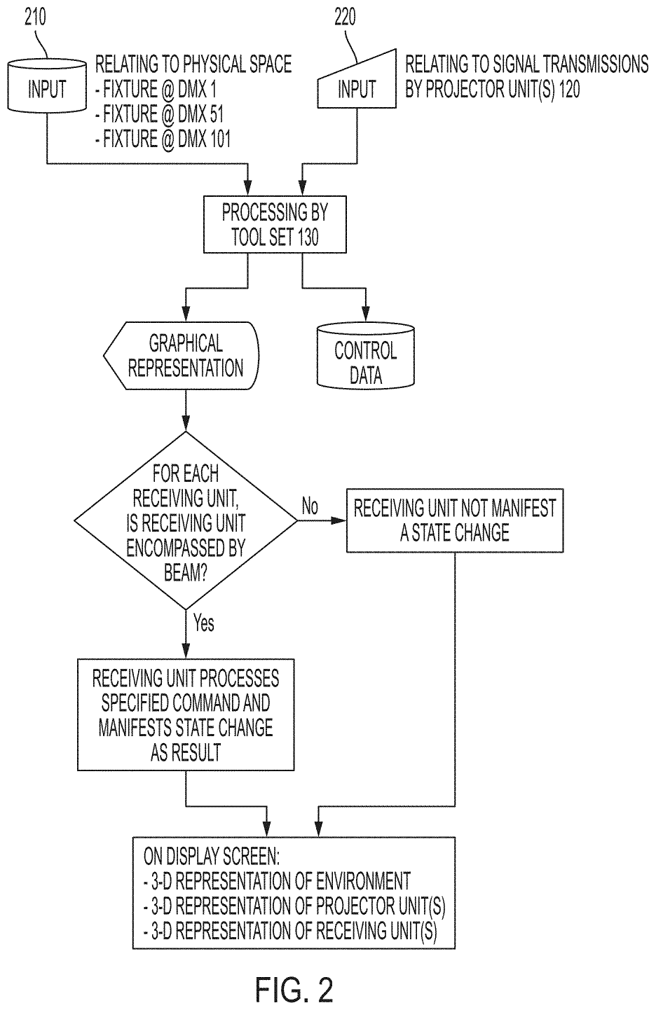

FIG. 2 depicts representative high-level processing performed by tool set 130 in the design and generation of a distributed manifestation. Tool set 130 receives input 210, comprising information specifying the physical characteristics of an environment (e.g., a stadium or arena in which is an event is to take place). For example, a “stadium model” (as is known in the art) may specify various physical characteristics of a facility in which an event is to take place, including its dimensions, elevations, the placement of seating sections, etc. In some embodiments, input 210 may also may specify an initial physical location for, and a logical address of, each projector unit 120 within the environment. For example, it can be seen in FIG. 2 that one projector unit 120 is assigned the logical address “fixture@DMX1”, another is assigned the logical address “fixture@DMX51”, and so on.

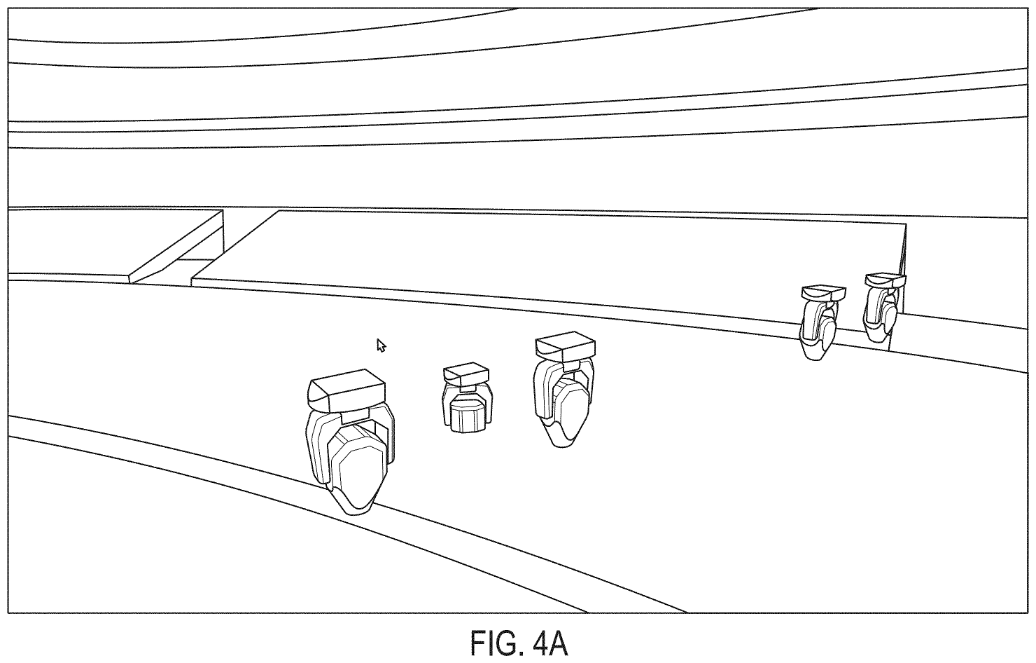

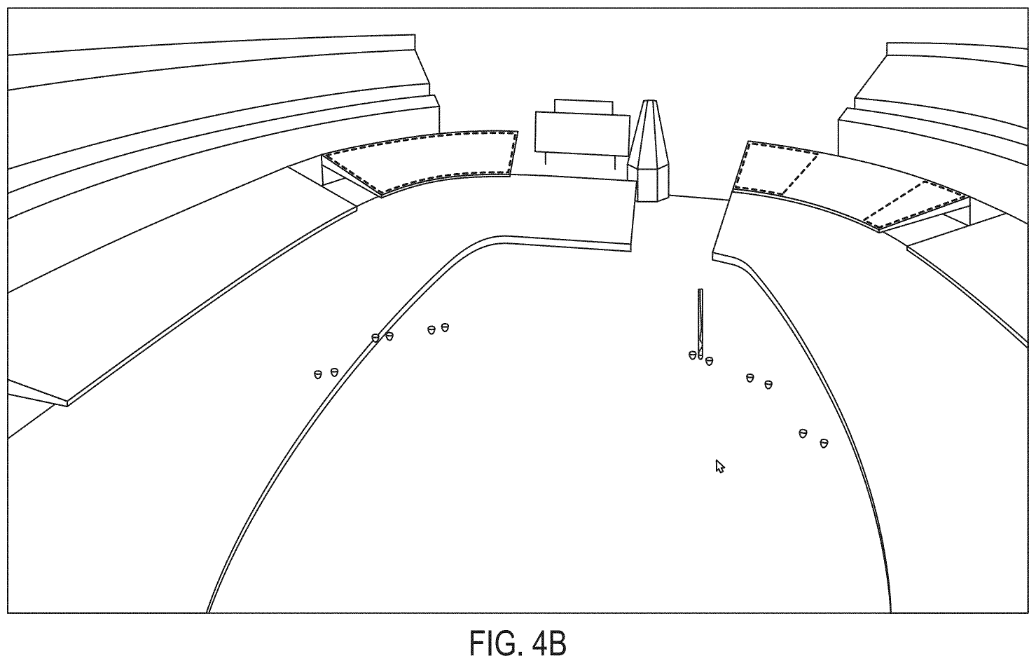

In some embodiments, a user may supplement input 210, such as by identifying specific areas within an environment. For example, as shown in FIG. 4B, a user may specify one or more seating sections in an environment. In the example shown in FIG. 4B, the user has outlined certain seating sections on a graphical representation generated by tool set 130, so as to allow him/her to specify a number of receiving units in each seating zone. Of course, a user may supplement input 210 in any suitable way, to supply any suitable information relating to an environment in which a distributed manifestation is to occur.

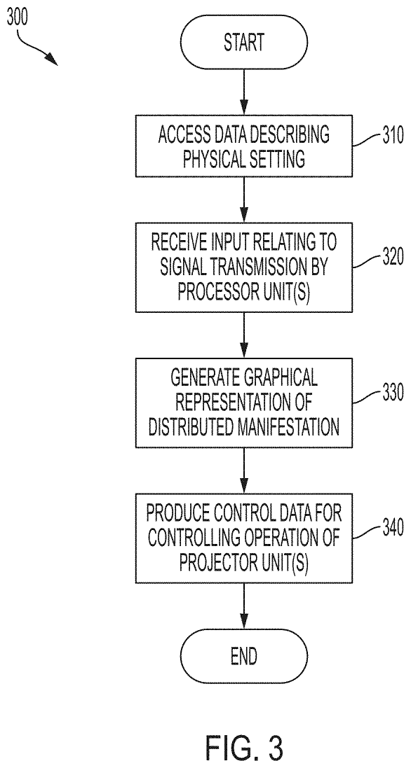

Input 220 is provided by a user to tool set 130 via a graphical user interface. In some embodiments, input 220 may specify one or more parameters relating to transmissions by one or more projector units 120 in the environment. For example, a user may specify the manner in which a particular projector unit changes position over time (e.g., by panning, tilting, etc.), its zoom rate, the information that is transmitted, whether any optic components are used, and/or other parameters. Some representative parameters relating to transmissions by one or more projector units are described in further detail below with reference to FIG. 3.

Inputs 210 and 220 are processed by tool set 130 to generate a three-dimensional graphical representation of a distributed manifestation within the environment, which the user may view from any of multiple perspectives. The representation, for example, show a user each projector unit in the environment, the transmission “beam” each produces at any one time, how that beam is incident upon receiving units in specific areas within the environment, how receiving units within those areas respond to received signals, and/or other aspects of a distributed manifestation. For example, a graphical representation may depict any receiving units encompassed at a given time by a beam from a projecting unit as manifesting a change in state as a result of processing commands encoded in transmissions in the beam, and may depict any receiving units which do not receive a transmission from a projecting unit at that time as not manifesting a change in state. As a result, a user may simulate different positions of, and movement by, various projector units in an environment to achieve different projection angles and different changes in state in different areas in the environment. The user may iteratively design various aspects of a distributed manifestation, to define in detail how it will unfold, and gain confidence that complex operations will be executed as desired to produce visually satisfying and compelling results. For example, by working with a simulation to “tune” various parameters, a designer may conceive of ways that projector units should sweep across areas in an environment, and what shapes, colors, patterns, and/or other elements should be used to generate a visually stunning experience for members of an audience. He/she may also work with a simulation to avoid undesirable effects, such as by ensuring that certain areas of an environment are not “left out” of a distributed manifestation, ensuring that transmissions are not obstructed by physical structures (e.g., lighting fixtures, equipment and/or decorative elements), positioning projector units so as to prevent transmissions being incident upon on receiving units from undesirable angles, avoid overlap of transmission beams (which can cause receiving units to react in unpredictable ways), etc. A user of tool set 130 may specify any of numerous other aspects of a distributed manifestation.

In some embodiments of the invention, tool set 130 may produce control data for us in controlling the operation of one or more projector units 120, to produce a distributed manifestation during an event. In some embodiments, the control data produced by tool set 130 for use in controlling one or more projector units 120 may be merged with data produced by control console 110A for controlling the operation of other components used during an event (e.g., lighting equipment), and the merged control data may be used to coordinate an overall display, such as one which encompasses transmissions of visible light from lighting equipment, and a distributed manifestation produced by receiving units processing transmissions from one or more projecting units.

### 2. Designing and Generating a Distributed Manifestation

FIG. 3 depicts a representative process 300 for designing and generating a distributed manifestation. Representative process 300 includes acts which may, for example, be performed by tool set 130.

At the start of representative process 300, data is accessed relating to a physical environment in which a distributed manifestation is to take place. For example, tool set 130 may access data specifying various physical characteristics of an environment, such as the dimensions, elevations, placement of seating sections, and/or other characteristics of a facility. The data may, for example, specify the position and characteristics of one or more projector units within the environment. A representative graphical representation which may be produced by tool set 130 from data received in the act 310 is shown in FIG. 4A. In the example shown, projector units 120 are shown as being disconnected from any physical support apparatus, although it should be appreciated that this need not be the case. In some embodiments, the data accessed in the act 310 may define not only the position of any projector units, but also that of any lighting fixtures, equipment and/or decorative elements to be used during the event.

Representative process 300 then proceeds to act 320, wherein user input is received which specifies one or more parameters relating to the transmission of electromagnetic signals by one or more projector units. For example, tool set 130 may provide a graphical user interface for receiving user input relating to the transmission of electromagnetic signals in the act 320. Based on this input, and the data received in the act 310, a graphical representation of a distributed manifestation is generated in the act 330. The graphical representation may, for example, depict receiving units in particular areas within the environment processing electromagnetic signals received from projector units. Representative parameters that may be defined in the act 320, and graphical representations that may be produced in the act 330, are described in further detail below.

Any of numerous parameters relating to transmissions may be defined in the act 320, in any of numerous ways. For example, user input to tool set 130 may identify the projector unit(s) that will transmit electromagnetic signals at any given time during an event, the position of each projector unit (and thus how any signals transmitted by each projector unit is incident upon an area within the environment), optics components to be used by one or more projector units in transmitting signals, any changes in position by a projector unit over time, the zoom rate and focus applied by a projector unit at any given time, degradation of signals transmitted by a projector unit, the number of receiving units within an area in the environment, the commands which are sent to receiving units in transmitted signals, and/or any of numerous other parameters relating to transmissions. The manner in which some of these parameters may be specified by a user of tool set 130 is described below.

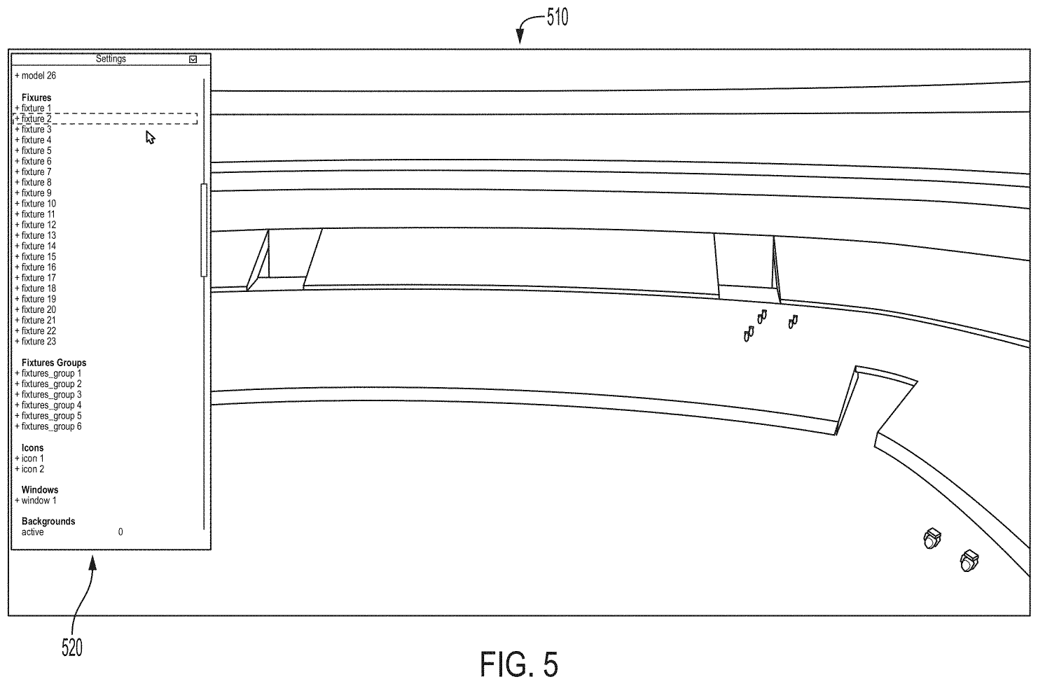

A representative interface 510 presented by tool set 130 is shown in FIG. 5. In the example shown, a portion of interface 510 graphically depicts the physical environment in which a distributed manifestation is to occur, and the position of one or more projector units in the environment. A panel 520 on interface 510 enables the user to supply input in relation to individual transmitters, listed on panel 520 as fixture 1, fixture 2, fixture 3, etc.

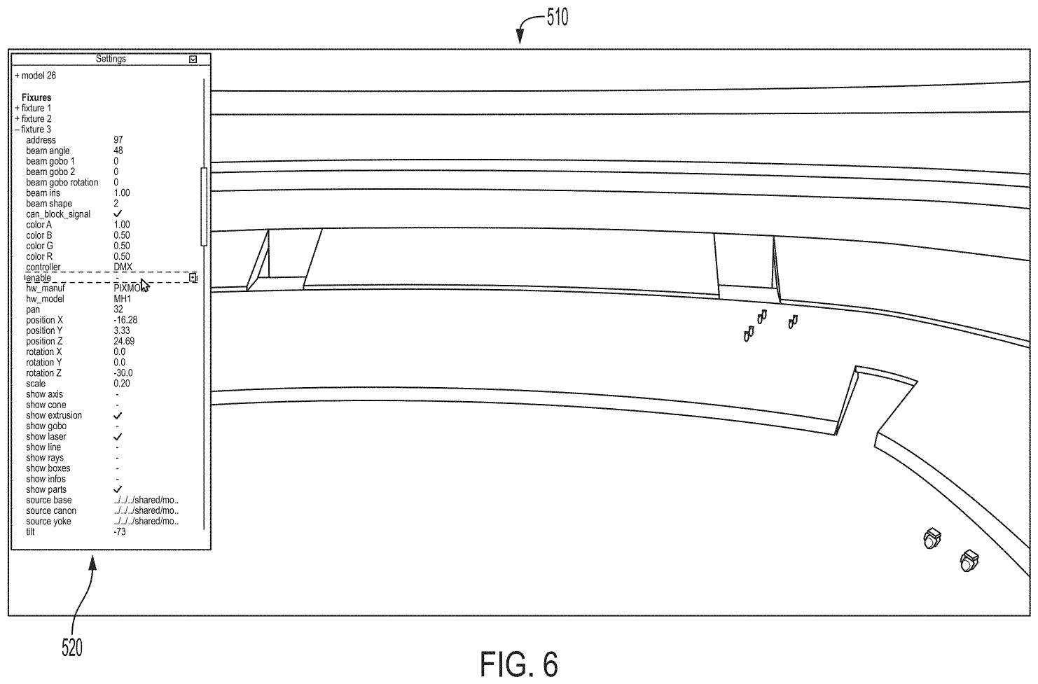

FIG. 6 shows representative interface 510 when the user provides input selecting fixture 3. It can be seen in FIG. 6 that a user may supply numerous types of input for this and other projector units, including its address, beam angle, one or more gobos, any gobo rotation, and other parameters. Some of these parameters are described in further detail below. In FIG. 6, a user has positioned a cursor over the “enable” parameter, which allows the user to control whether a transmission of electromagnetic signals is to be simulated.

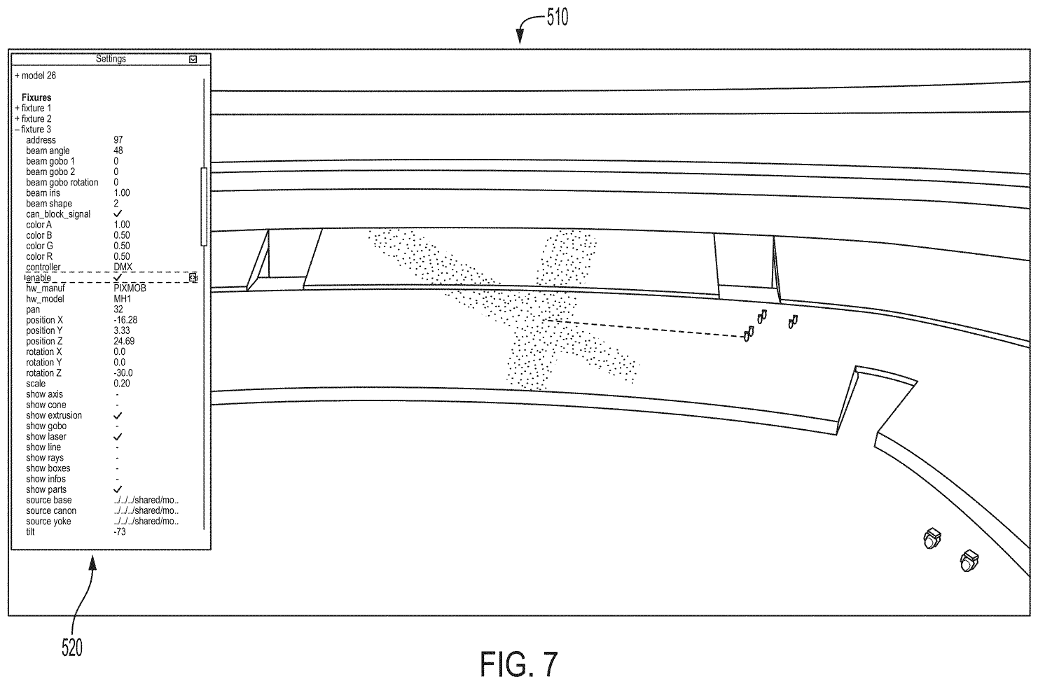

FIG. 7 depicts interface 510 after the user has selected the “enable” parameter (indicated by the checkmark now appearing next to the parameter in FIG. 7). Interface 510 depicts an area within the environment (i.e., sections of a stadium) in which receiving units receive the simulated transmission from the projecting unit and manifest a change in state as a result. Of course, the receiving units that receive the transmission depend upon the projector unit's position, its orientation, its zoom level and focus, the strength of the transmission, and whether the signal degrades after transmission prior to reaching the receiving units, among other variables. Using interface 510, a user may make changes to various variables, and to visualize how a transmission according to specified parameters will cause receiving units to react.

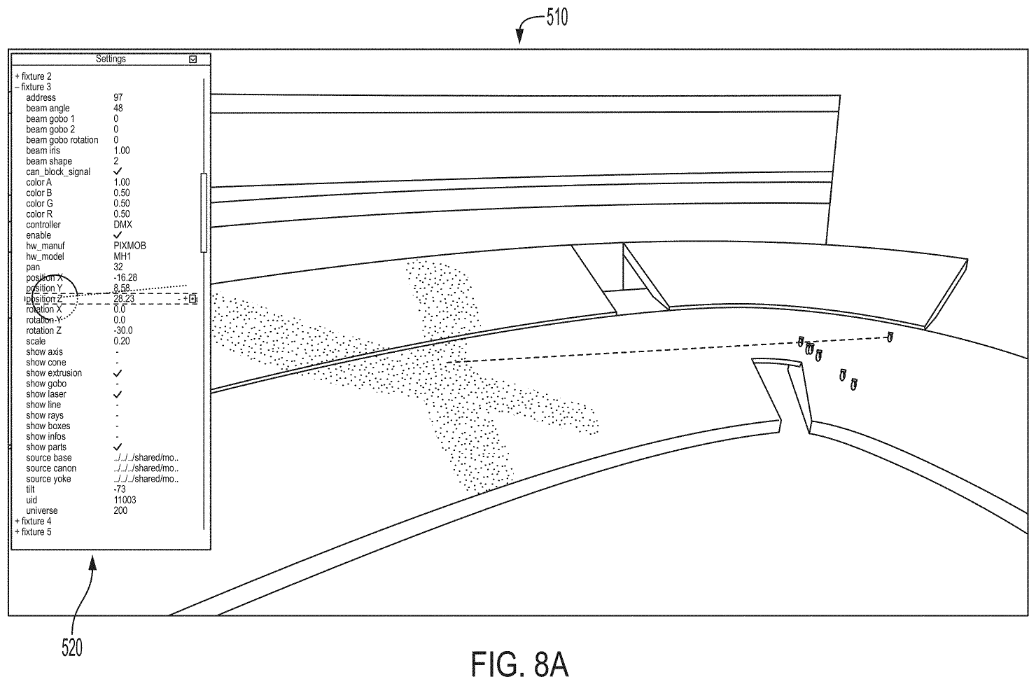

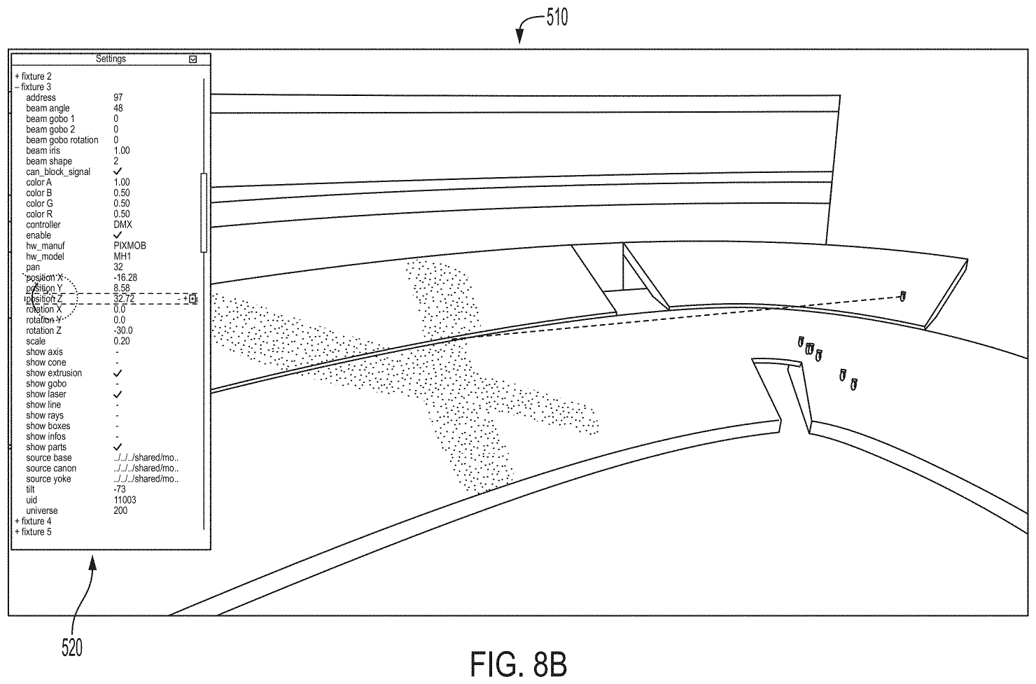

FIGS. 8A-8B depict how a user may specify the position of a projector unit within an environment. It can be seen in FIG. 8A that a user has selected the “position Z” parameter (which, in the example shown, enables the user to specify a position along the Z-axis, or height) for the projector unit known as fixture 3. Selecting this parameter has caused a dial to appear in FIG. 8A, which the user may employ to vary the height of the projector unit. It can be seen that the user has increased the position of the projector unit on the Z-axis to “28.23”, so that the projector unit is positioned above the other projector units depicted in FIG. 8A. FIG. 8B depicts the user having raised the projector to a height of “32.72”. It can be seen in FIGS. 8A-8B that moving the projector unit in this manner causes different receiving units (i.e., located higher in the stadium) to receive transmissions from the projector unit.

Of course, a tool set implemented in accordance with the invention may enable the position of a projector unit to be modified in any of various ways. It can be seen in FIGS. 8A-8B that a user may also modify the position of a projector unit along the X- or Y-axes, and modify the rotation of a projector unit along the X-, Y-, and/or Z-axes.

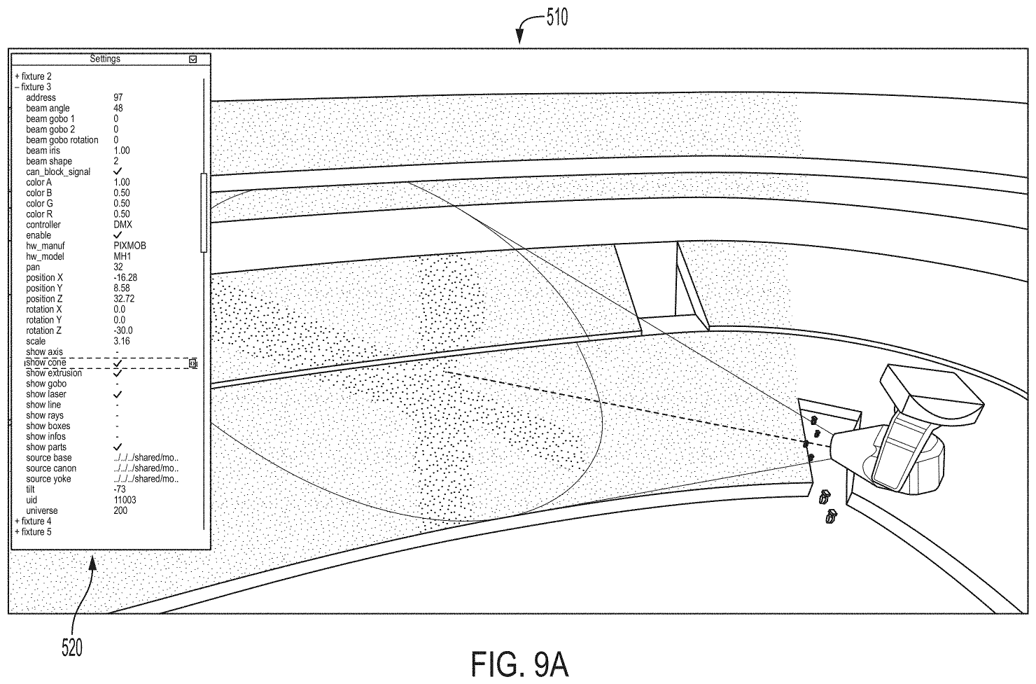

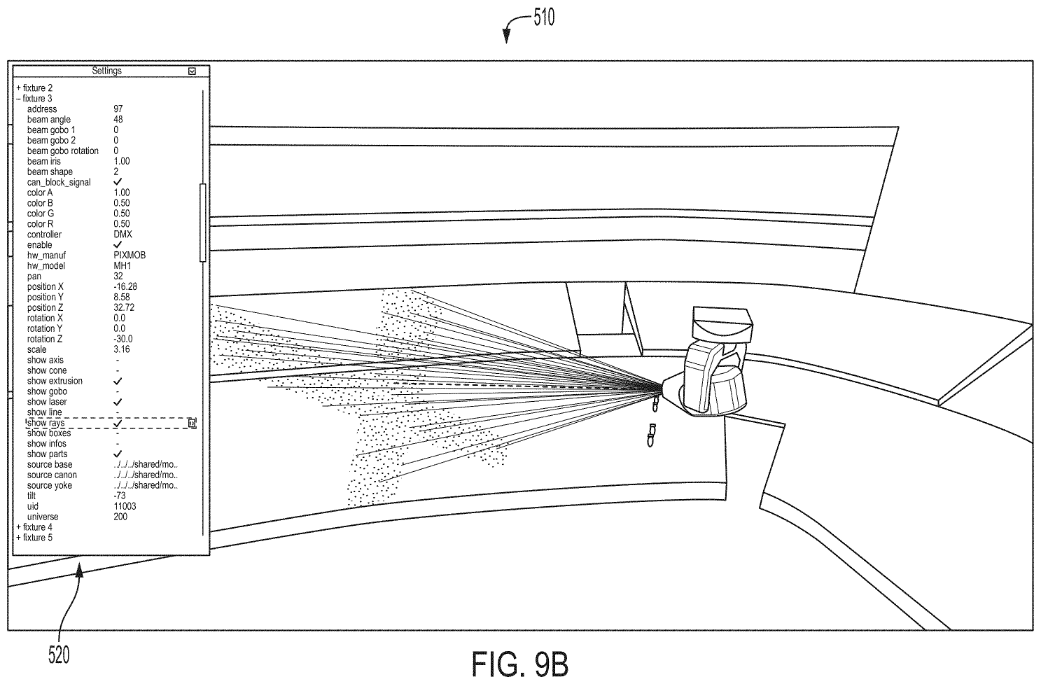

FIG. 9A depicts interface 510 after the user selects the “show cone” parameter on panel 520. It can be seen that doing so allows the user to see the area encompassed by the beam transmitted by a projector unit. As a result, the user may see whether portions of the beam are incident upon areas where no receiving units reside, whether a particular area encompassed by the beam from one projector is also receiving a beam from another projector unit, etc., and make changes so as to avoid any undesirable effects. For example, a user may wish to avoid an area receiving beams from more than one projector at a time, as this may cause receiving units in the area of overlap to not manifest a change in state, or react in an unpredictable fashion.

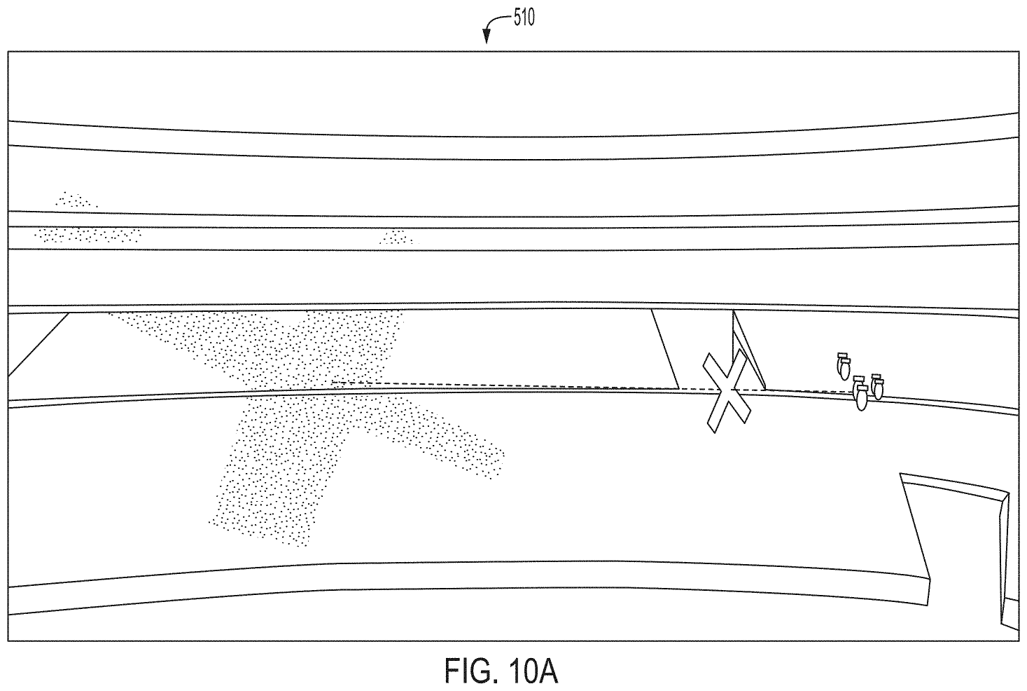

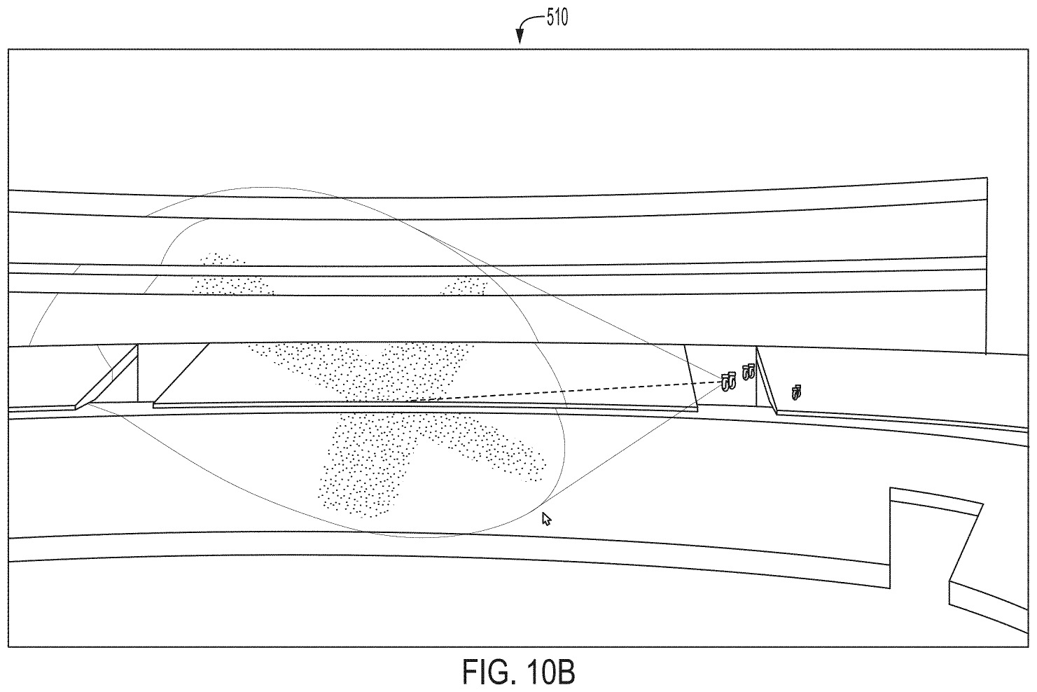

FIG. 9B depicts interface 510 after the user selects the “show rays” parameter. It can be seen that doing so allows the user to see which regions within the overall area encompassed by the beam are actually receiving electromagnetic signals. In this respect, it can be seen from FIGS. 7, 8A-8B and 9A-9B that only certain receiving units within the overall area encompassed by the beam from the projector unit are manifesting a change in state, indicating that a gobo is being used to mask a portion of the beam. The graphical representation in FIG. 9B allows the user to see which areas defined by a beam are actually receiving signals. FIGS. 10A-10B depict interface 510 symbolically showing the gobo, and the result of using the gobo, respectively. Some embodiments may enable a user may be able to simulate rotation of a gobo, so as to see the effect of doing so on receiving units.

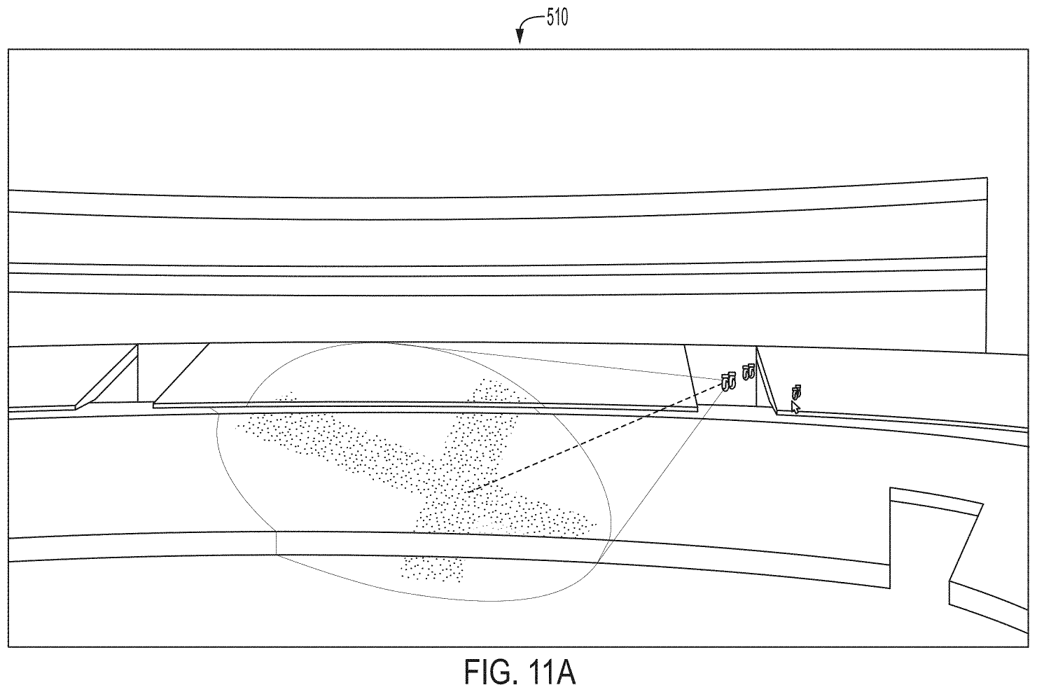

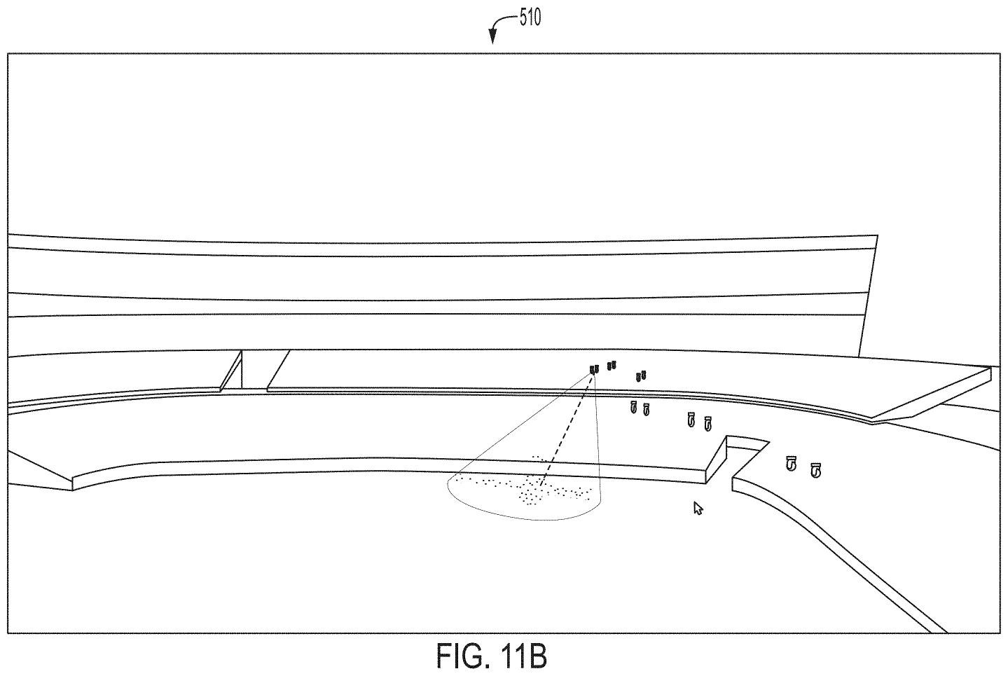

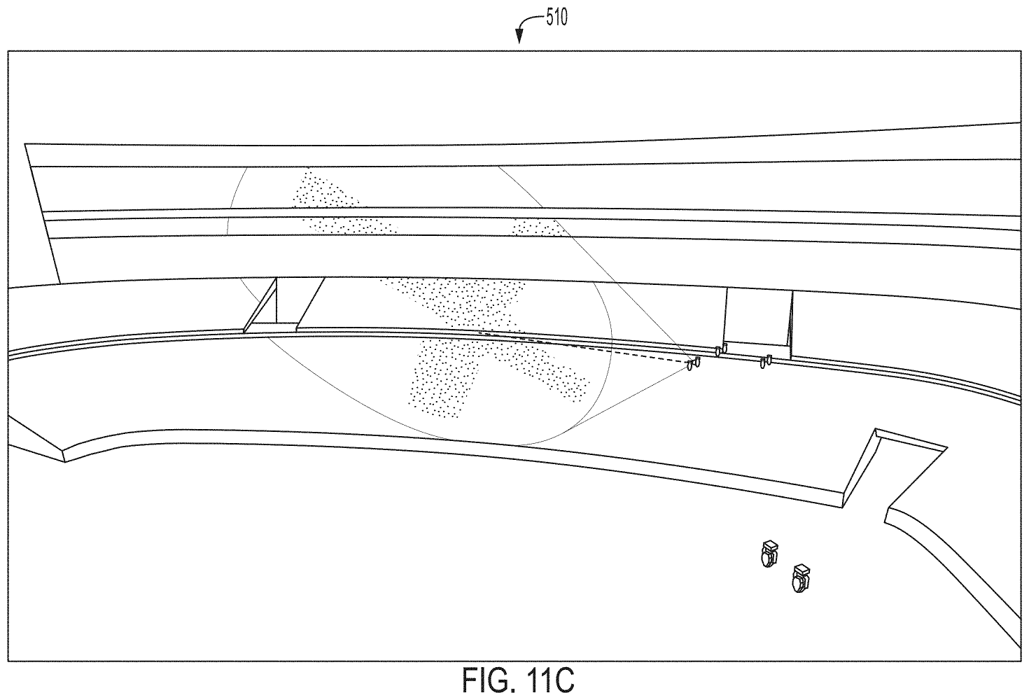

FIGS. 11A-11C depict interface 510 after the user modifies a parameter affecting the tilt of the projector unit. It can be seen from the difference between FIG. 11A and FIG. 11B that the modification results in the beam projected by the projector unit moving and becoming incident upon receiving units in a different area, from a group of receiving units in the upper stands of a stadium to a group on the floor of the stadium. The difference between FIG. 11B and FIG. 11C indicates that the beam has moved again, and become incident again upon a group of receiving units in the upper stands of the stadium. By simulating the manner in which a projector unit tilts over time, a user can ensure that the beam transmitted thereby produces the desired visual effect. For example, the user may ensure that the tilt of a projector does not cause it to transmit above the walls of a stadium, to an area in which no receiving units reside, etc. The user may also ensure that the tilt of a projector unit creates an area encompassed by a beam of desirable shape. For example, the physical characteristics of a space can cause an area of exceedingly oblong shape to be encompassed by a beam, if the tilt of a projector unit is set at a particular angle, and a user of tool set 130 may find this undesirable.

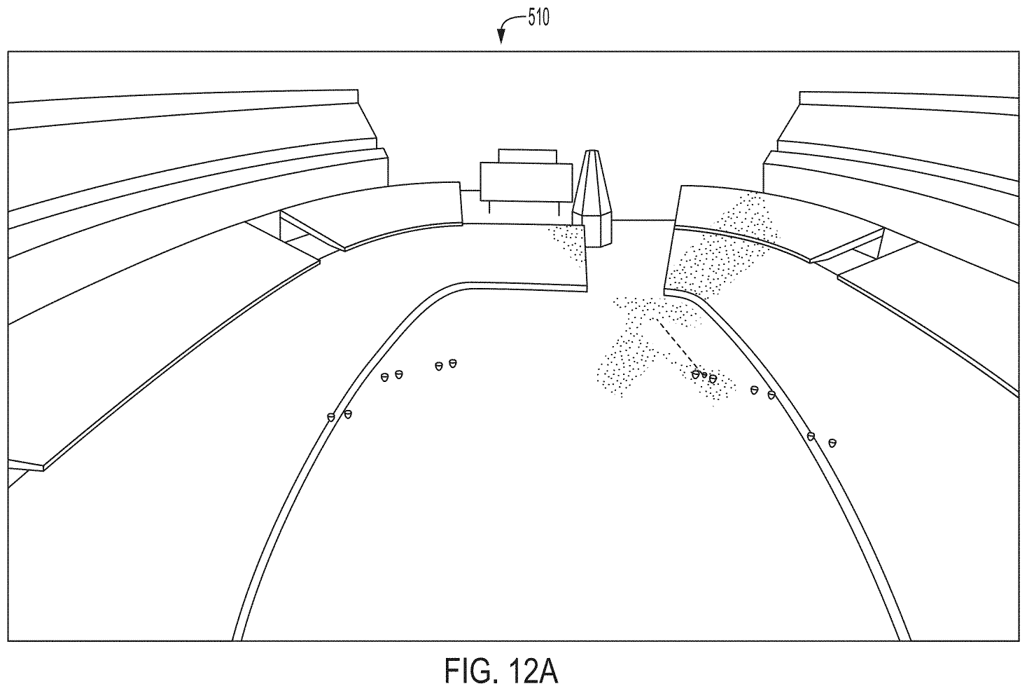

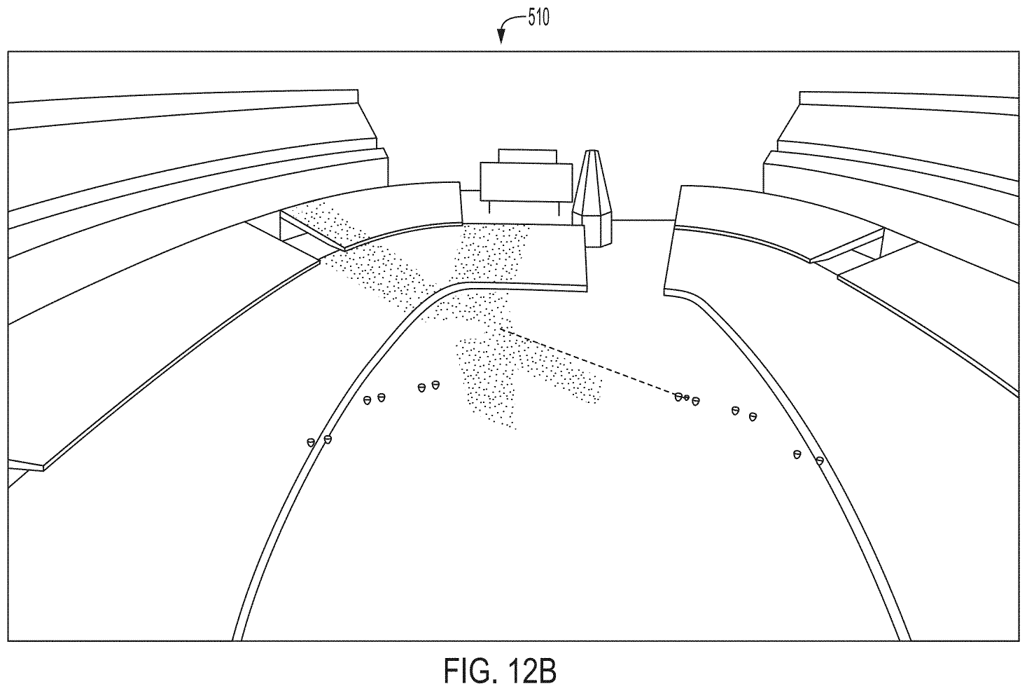

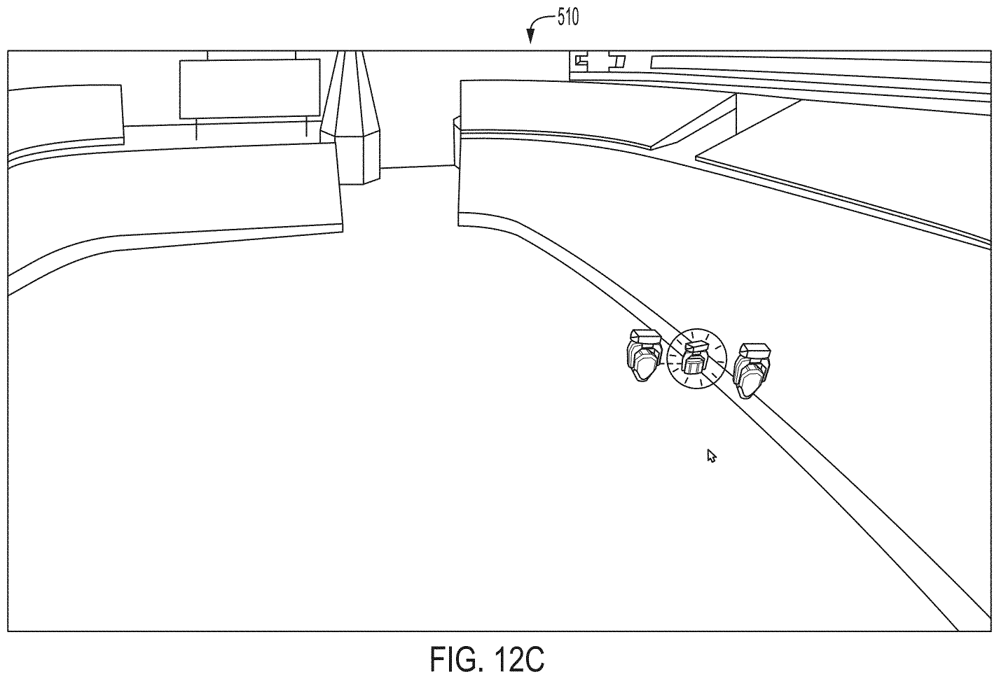

FIGS. 12A-12B depict interface 510 after a user modifies a parameter affecting the pan of the projector unit. The difference between FIGS. 12A and 12B indicates that the user has specified that the beam is to sweep from right to left. Of course, the pan of a projector unit may be specified to change over time in any suitable manner.

As with the tilt parameter described above, by simulating changes in a projector unit's pan over time, a user can design visually satisfying effects, and ensure that transmissions do not create undesirable results. As an example of an undesirable result, FIG. 12C shows interface 510 after a user-specified pan operation results in the beam from a projector unit being obstructed by another fixture. In the example shown in FIG. 12C, when a projector unit's beam becomes obstructed by another fixture, the projector unit is shown with visual highlighting. Of course, an obstruction or other undesirable effect may be indicated to a user in any suitable manner, such as via visual highlighting, sound, etc. A user may act on this indication by, for example, modifying the position and/or orientation of the projector unit, or of the feature that creates the obstruction.

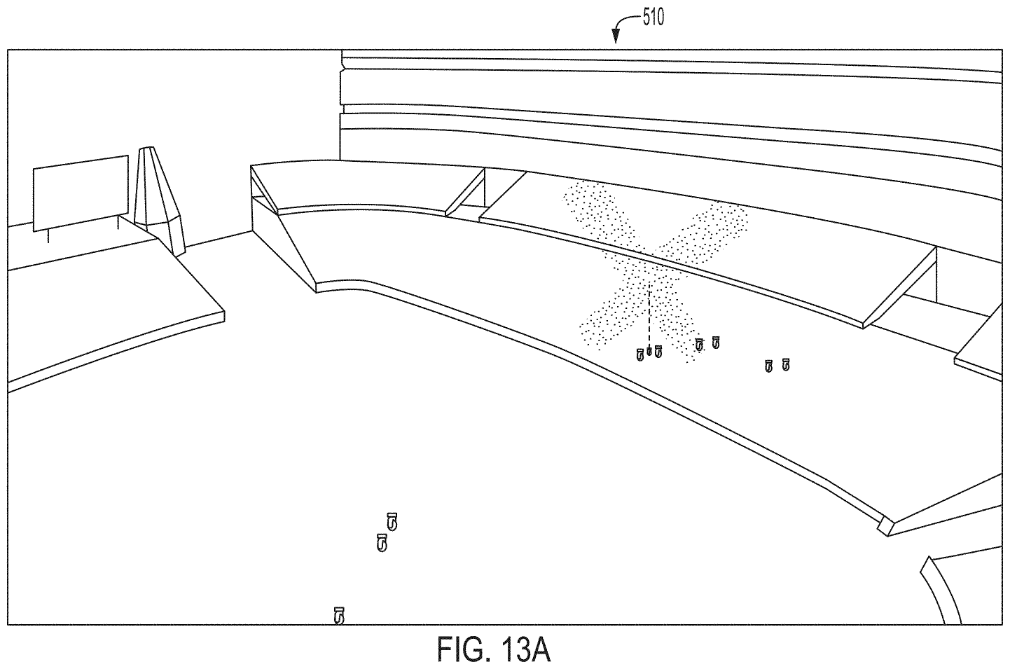

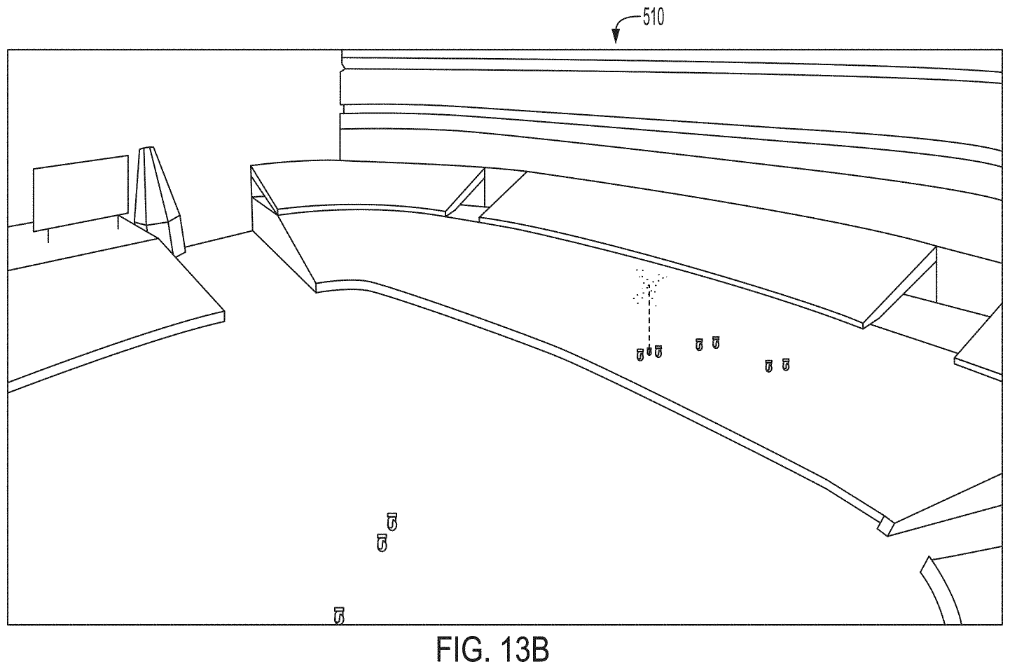

FIGS. 13A-13B depict interface 510 after a user modifies a parameter affecting the zoom rate of a projector unit. In the example shown, FIG. 13A depicts a first zoom rate in use and FIG. 13B depicts a second, greater zoom rate in use. It can be seen from the difference between FIGS. 13A and 13B that increasing the zoom rate of a projector unit causes its beam to encompass a much smaller area within the environment. Those skilled in the art will appreciate that decreasing the zoom rate of a projector unit may also decrease the distance over which a signal transmitted by the projector unit will reliably travel. Thus, in some embodiments, tool set 130 may account for this by simulating signal degradation when a user decreases the zoom rate for a projector unit, enabling the user to see how these settings affect a distributed manifestation produced as a result.

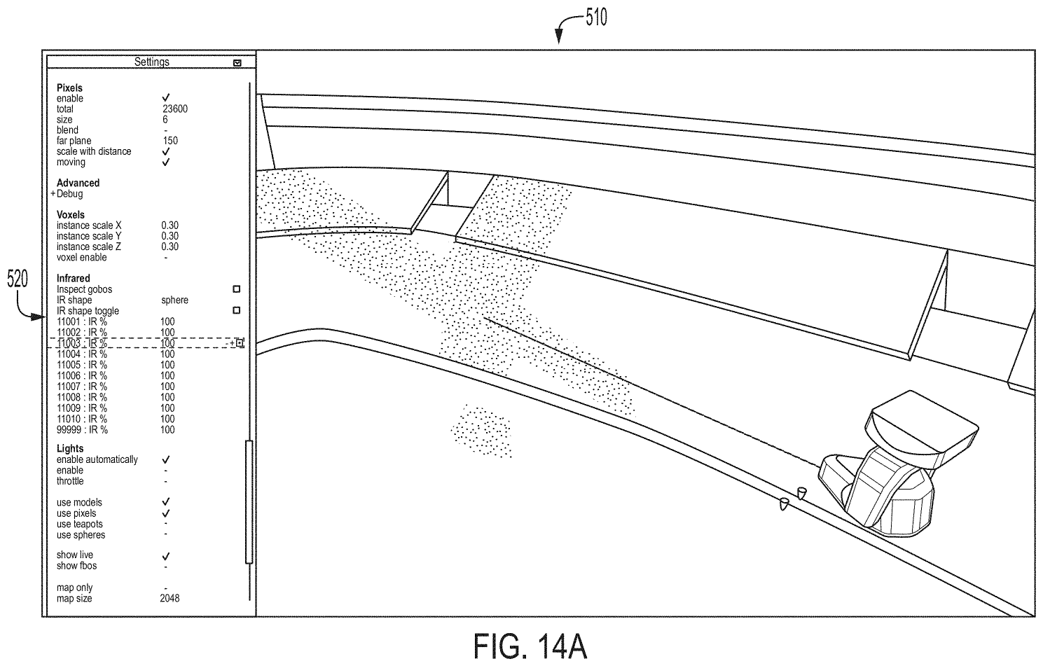

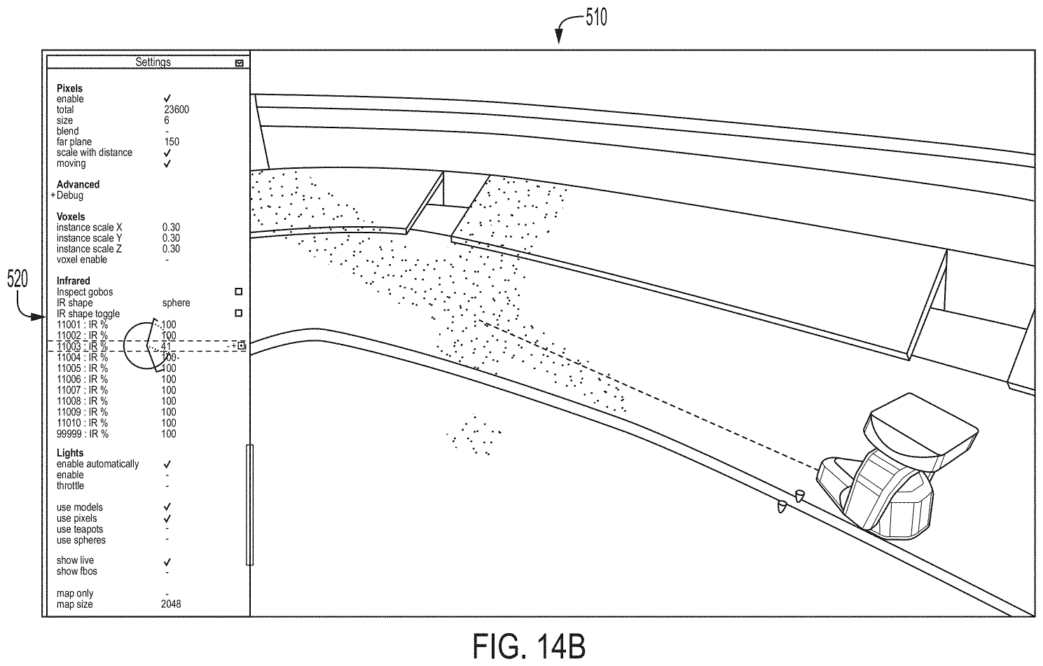

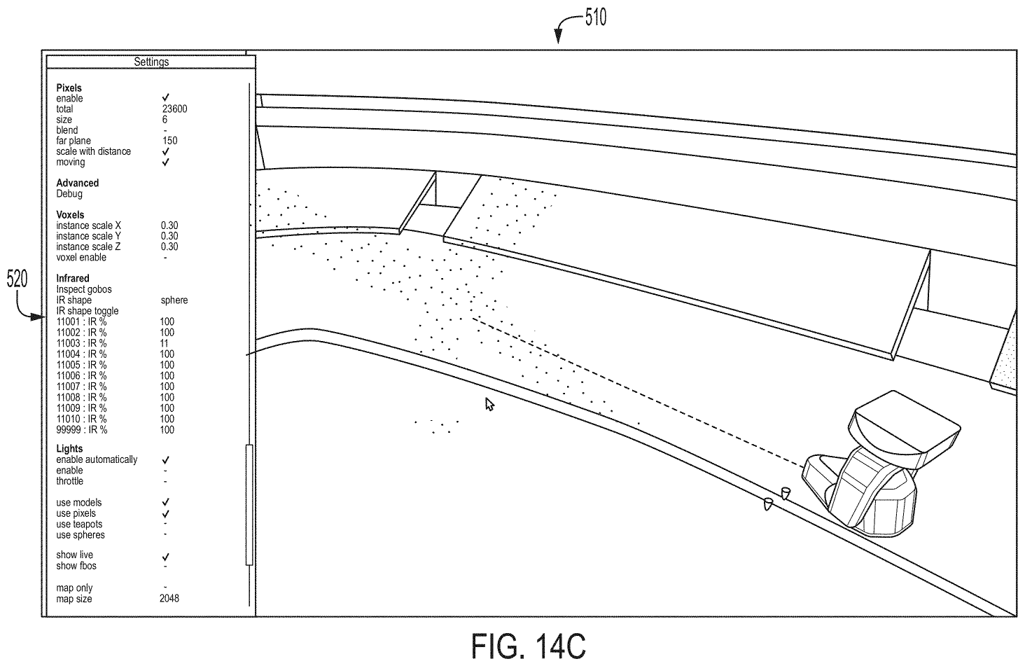

FIGS. 14A-14C depict interface 510 after a user modifies a signal degradation parameter. In this respect, a signal transmitted by a projector unit may degrade for reasons other than the zoom rate in use by the projector unit. For example, the distance between a projector unit and receiving units, the positioning of a receiving unit when a signal arrives, and other variables can affect whether the signal reliably reaches the receiving unit. As such, tool set 130 may enable a user to simulate levels of signal degradation, and see the distributed manifestation that results. In FIG. 14A, it can be seen that a user has selected a projector at address “11003” in the section of panel 520 labeled “infrared”. FIG. 14B shows that selection of this transmitter causes a dial to be presented which the user may employ to specify signal degradation. In the example shown, the user has modified the signal from no degradation (i.e., 100%) to 41%. It can be seen from the difference between FIGS. 14A and 14B that doing so results in many fewer receiving units manifesting a change in state as a result. FIG. 14C shows interface 510 after the user has specified signal degradation to only 11%, and the number of receiving units which manifest a change in state as a result.

In some embodiments, tool set 130 may enable a user to define a number of receiving units located within specific areas in an environment. For example, a user may define a number of event attendees wearing a receiving unit in one or more seating sections in a stadium. Doing so may enable the user to see how the changes to the number of receiving units affect how faithfully certain images (e.g., shapes or objects) are rendered. In this respect, those skilled in the art will recognize that certain shapes or objects may not be visually discernible if the number of receiving units within a given area is below a minimum threshold. By modifying the number of receiving units in an area within a setting, the user may be able to see whether shapes and objects are satisfactorily displayed.

In some embodiments, a user may specify one or more commands that are transmitted by a projector unit to receiving units, and thus how the receiving units that receive the transmission manifest a change state as a result of processing the commands. As one example, a user may specify a sequence of commands to be transmitted by a projector unit which, when processed, will cause receiving units to light up in a sequence of different colors. As another example, a user may specify that one projector unit is to send one set of commands to a first area within an environment, and that a second projector is to send another set of commands to another area at the same time, to visualize the result of the different groups of receiving units processing different commands at once.

It should be appreciated that although FIGS. 11A-11C, 12A-12B, 13A-13B and 14A-14C depict the result of separately modifying individual transmission parameters, a tool set implemented in accordance with the invention is not limited to functioning in this manner. Any suitable combination of parameters may be modified at the same time, to produce any suitable combination of pan, tilt, zoom and other projector unit operations, and other aspects of a distributed manifestation, as desired.

It should also be appreciated that by allowing a user to modify parameters relating to transmissions by one or more projector units, some embodiments of the invention may enable the user to treat an environment depicted in interface 510 as a canvas, so as to “paint” visually stunning effects in an environment using a combination of colors, shapes, patterns, etc. A user may employ tool set 130 to make creative decisions around, for example, how a projector unit should sweep across a bowl, what position a projector unit should be in to best create a particular shape in visually discernible form, whether different colors included in a distributed manifestation create a desired effect, etc. These decisions would be exceedingly difficult, if not impossible, to make in the abstract without significant guesswork by the user, given the complex geometry of many physical settings, the variability with which receiving units may be disposed in different areas within a setting, the numerous ways that projector units may process signals, and the numerous ways that receiving units may process them. Some embodiments of the invention enable a user to overcome these complexities and significantly mitigate the risk that a distributed manifestation may not turn out as desired. Moreover, enabling a designer to work with a distributed manifestation iteratively over time before an event is to occur may provide him/her the confidence to attempt visual effects that he/she might otherwise be unwilling to try. For example, a designer may devise an effect that involves complex sequences of commands being transmitted in a highly coordinated fashion to particular groups of receiving units in an environment, and work with tool set 130 over time to perfect it before unveiling it in a particular environment. Without the ability to simulate the effect beforehand, and test and refine it over time until he/she is satisfied with it, the designer may be unwilling to attempt it during an event for fear that it may not turn out as desired. As such, some embodiments of the invention may enable the design and orchestration of distributed manifestations than might not otherwise be attempted.

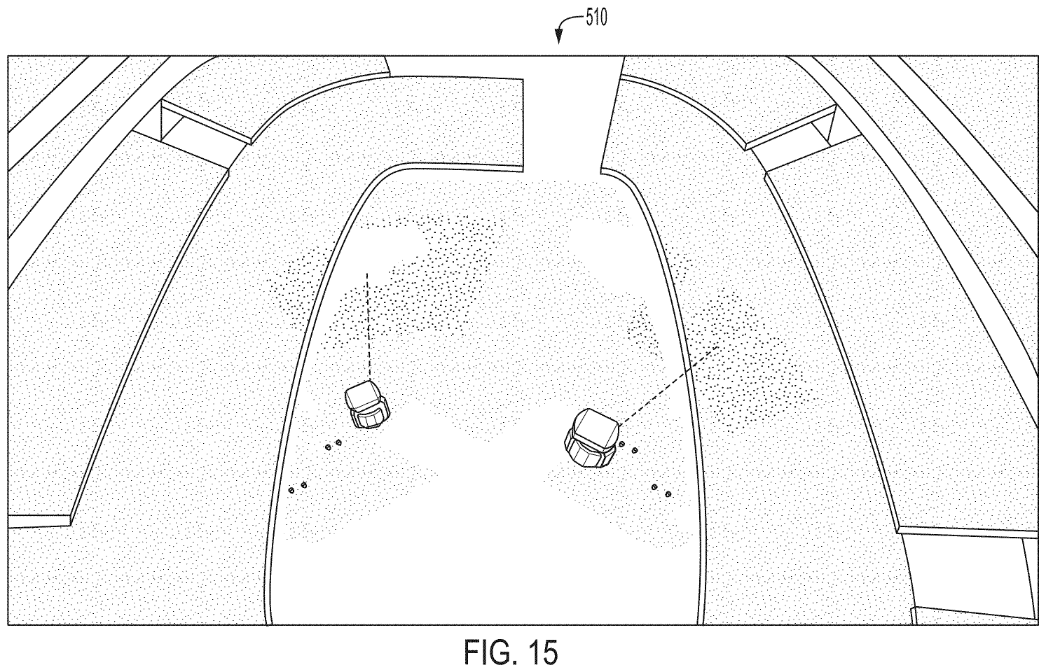

Although many of the examples given above relate to transmissions by a single projector unit, it should be appreciated that tool set 130 may enable a user to define parameters relating to transmissions by multiple projector units at once, thus allowing the user to coordinate effects across the projector units. An example, involving two projector units, is shown in FIG. 15. Using tool set 130, a user may specify that the two projectors pan and/or tilt in synchronized fashion or move independently, that the projectors transmit electromagnetic signals to cause receiving units to manifest the same or different changes in state, that the beams produced by the projector units collectively create shapes, patterns, stage change sequences, and/or any other desired effect(s). By coordinating transmissions by multiple projector units, with each transmission potentially being characterized by different parameters, a user may simulate the creation of sophisticated imagery in a setting.

In some embodiments, tool set 130 may provide various features enabling a user to synchronize or otherwise set elements of a distributed manifestation to music, such as a musical performance that is to occur at the same time in the physical space. As one example, tool set 130 may provide functionality which allows a designer to use the “time code” for a musical piece (i.e., indicating when certain portions of the piece are to begin or end) to set elements of a distributed manifestation to occur at the same time(s).

As another example, tool set 130 may enable a user to tune aspects of a distributed manifestation based upon how an audience is expected to respond to portions of a musical performance. For example, if it is known that during certain songs by a musical performer, audience members are more likely to be sitting than dancing, then the user may specify that the strength of transmission by one or more projector units should be increased during these songs to account for the fact that there are more likely to be physical obstructions (i.e., the audience members themselves, as people often sit with their hands in their laps) which could prevent transmissions from reaching receiving units. Conversely, the user may decrease the strength of transmissions during other songs when audience members are more likely to be dancing, as they typically raise their hands when doing so and thus expose receiving units to transmissions.

Of course, transmission parameters need not be adjusted on a song-by-song basis. For example, if it is observed that, in general, about 75% of the audience at a particular artist's concerts are dancing at any one time, then the user may employ this information in configuring the strength of transmissions overall.

In some embodiments, tool set 130 may also enable a user to synchronize or otherwise set elements of a distributed manifestation to lighting produced during an event. For example, in some embodiments, tool set 130 may receive as part of input 210 (FIG. 2) information which identifies lighting fixtures and specifies how those fixtures will emit light in an environment over time. A designer may employ this information to (for example) achieve contrast between colors emitted by lighting fixtures and colors generated by receiving units, avoid transmitting signals toward groups of receiving units when they are bathed in visible light, exploit the differences in how the audience perceives light from a lighting fixture and light from receiving units to create a unified and synchronized overall effect (e.g., by specifying that lighting fixtures first emit blinding light, then the space goes completely dark, and then certain receiving units light up). A user may coordinate visible light from lighting fixtures and manifestations of changes in state by receiving units in any of numerous ways.

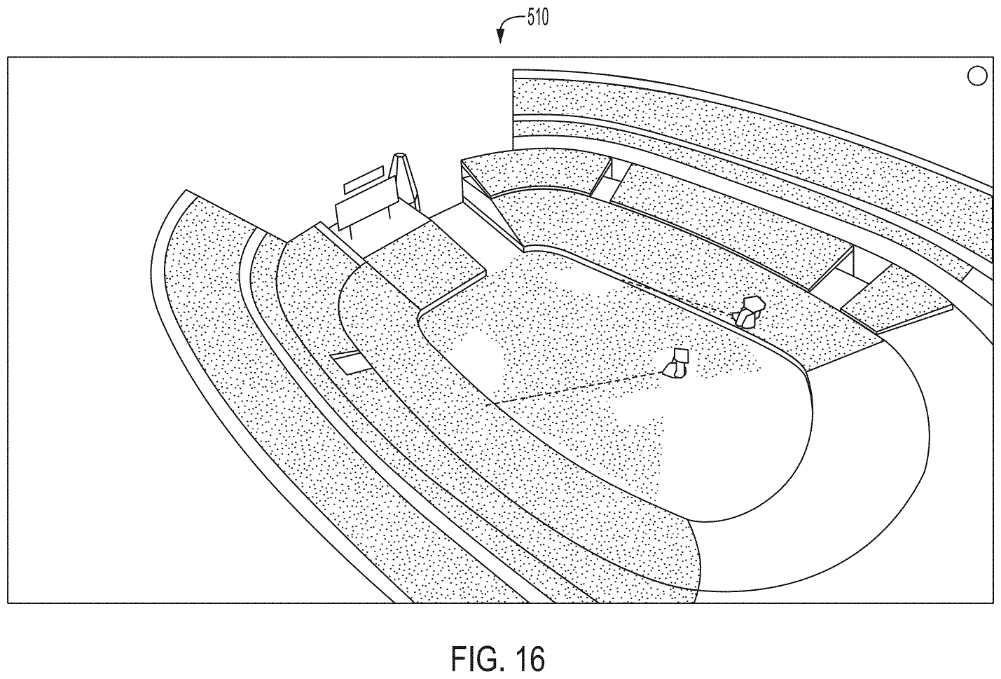

It should be appreciated that although much of the description above relates to designing a distributed manifestation produced using projector units configured to move, the invention is not limited to such an implementation. For example, tool set 130 may be used to design distributed manifestations created using a transmitter like that which is described in the “Background” section above, which projects the same signals at a given time to all receiving units in range. For example, tool set 130 may enable a designed to tune one or more transmission parameters so as to achieve greater precision in such a display, such as by ensuring that signals are being transmitted to all areas in an environment, with sufficient strength to cause the desired number of receiving units to manifest a change in state, etc., as illustrated in FIG. 16.

Referring again to FIG. 3, at the completion of act 330, representative process 300 proceeds to act 340, wherein control data is generated for use in controlling one or more projector units. For example, tool set 130 may process the input received in acts 320 and 330 to generate control data for controlling the operation of one or more projector units 120. Control data may be generated in any suitable format. For example, control data may be generated in a DMX format, as is known in the art.

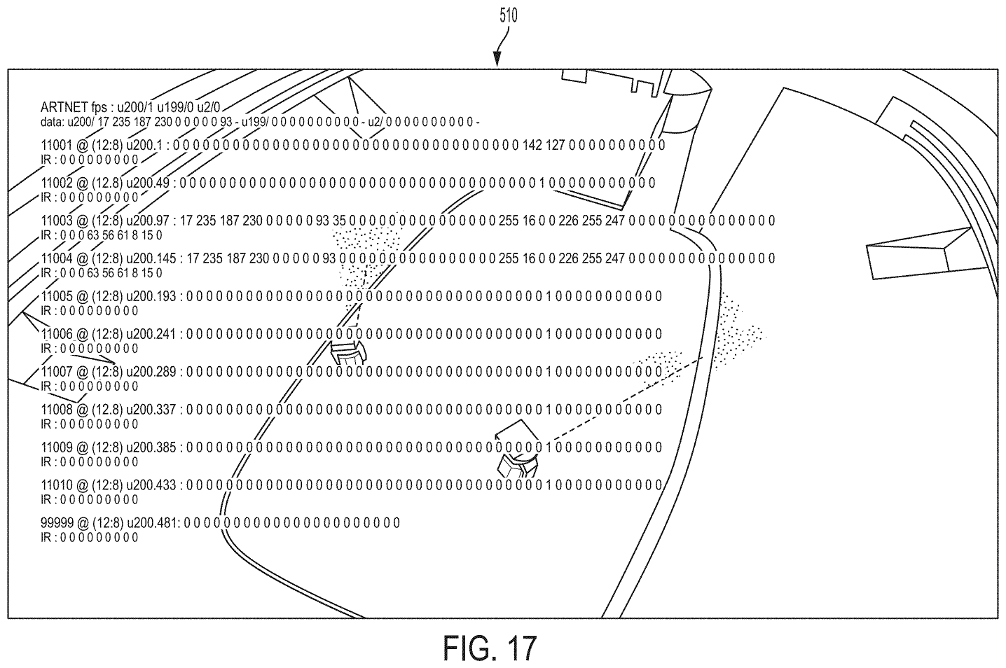

FIG. 17 depicts a representative set of control data for controlling the operation of projector units in an environment. Specifically, FIG. 17 depicts a set of control data for each of a series of projector units (labeled 11001, 11002, 11003, etc.) during a particular time interval. In FIG. 17, the numerals provided after the colon for each projector unit reflect control commands for the projector unit during the considered time interval. The control commands may instruct a projector unit (for example) how to move, what information to transmit, the strength at which to transmit, what zoom rate to apply to transmissions, whether to employ an optics component, and/or other operations to perform during the interval. By creating a simulation using tool set 130, a user may generate a data set spanning a distributed manifestation during an event.

In some embodiments, control data generated in the act 340 may be provided to control console 110A for use in controlling all of the fixtures in use during an event, including any lighting fixtures, projector units, and/or other equipment. In these embodiments, control console 110A may provide control data to one or more projector units 120 at any suitable rate. For example, in some embodiments, control data may be provided to projector unit(s) 120 at thirty frames per second, twenty frames per second, and/or at any other suitable rate. In some embodiments, a node corresponding to each projector unit 120 may receive control data intended for the projector unit and modify the frame rate of the control data, to achieve any of numerous objectives. For example, a node corresponding to a projector unit 120 may receive control data from control console 110A at thirty frames per second and provide the control data to the projector unit at twenty frames per second. Of course, the invention is not limited to such an implementation.

Additionally, in some embodiments, the control data generated in the act 340 need not be provided to control console 110A. For example, as described further below, tool set 130 may directly control one or more projector units via the generation of control data.

At the completion of act 340, representative process 300 completes.

### 3. Other Applications

It should be appreciated that tool set 130 may have numerous uses beyond enabling a user to simulate a distributed manifestation in an environment. As one example, tool set 130 may be used to verify that the programming for a distributed manifestation produces desired visual effects. For example, using data indicating how receiving units pre-programmed in various ways are to be placed in an environment, tool set 130 may be used to verify that the pre-programming for receiving units in particular areas within an environment has been performed correctly to achieve desired effects, given the signal transmissions which are to occur during a given distributed manifestation.

Tool set 130 may also, or alternatively, be used to perform this pre-programming. In this respect, it should be appreciated that signals sent by a projector unit 120 may include instructions to any receiving unit which receives the signal to program itself to respond to subsequent signals in certain ways. By simulating the transmission of such signals beforehand, a user may define the areas in which receiving units receive certain programming with greater precision than might be achieved by manually programming the receiving units, potentially enabling the creation of more sophisticated visual effects. In a similar manner, tool set 130 may enable the programming of the firmware of various projector units and/or other components used in producing a distributed manifestation.

Tool set 130 may also, or alternatively, be used to control a distributed manifestation in real time. For example, as a user instructs tool set 130 to simulate certain effects, tool set 130 may generate control data and provide the control data to one or more projector units substantially in real time. A user may therefore “paint” an audience in real time, as an event takes place, in a role akin to a disc jockey for visual effects.

As another example, tool set 130 may produce a virtual- or augmented-reality-based representation of a distributed manifestation, instead of or in addition to a graphical representation suitable for display on a screen. For example, tool set 130 may generate output suitable for rendering as a virtual- or augmented-reality version of a distributed manifestation, so that (for example) a designer may view a distributed manifestation from an audience member's or performer's perspective, set to music, with accompanying lighting displays, and/or incorporating other elements.

Any of numerous modifications may be made to the particular embodiments of the invention disclosed above. It should be appreciated that such alterations, modifications, and improvements are intended to be part of this disclosure, and are intended to be within the spirit and scope of the invention. Further, although some advantages provided by embodiments of the invention are described above, it should be appreciated that not every embodiment will include every described advantage, and that some embodiments may not implement certain features described as advantageous herein. Accordingly, the foregoing description and drawings are by way of example only.

### 4. Detail Regarding Representative Implementation

It should be apparent from the foregoing that some embodiments of the invention may be implemented using a computing system. FIG. 18 illustrates one example of a suitable computing system 1800 which may be used to implement certain aspects of the invention. The computing system 1800 is only one example of a suitable computing system, and is not intended to suggest any limitation as to the scope of use or functionality of the invention. Neither should the computing system 1800 be interpreted as having any dependency or requirement relating to any one or combination of components illustrated in the exemplary computing system 1800. In this respect, embodiments of the invention are operational with numerous other general purpose or special purpose computing systems or configurations. Examples of well-known computing systems and/or configurations that may be suitable for use with the invention include, but are not limited to, personal computers, server computers, mobile or laptop devices, multiprocessor systems, microprocessor-based systems, set top boxes, programmable consumer electronics, network PCs, minicomputers, mainframe computers, distributed computing systems that include any of the above systems or devices, and the like.

The computing system may execute computer-executable instructions, such as program modules. Generally, program modules include routines, programs, objects, components, data structures, etc. that perform particular tasks or implement particular abstract data types. The invention may also be practiced in distributed computing systems where tasks are performed by remote processing devices that are linked through a communications network. In a distributed computing system, program modules may be located in both local and remote computer storage media including memory storage devices.

FIG. 18 depicts a general purpose computing device in the form of a computer 1810. Components of computer 1810 may include, but are not limited to, a processing unit 1820, a system memory 1830, and a system bus 1821 that couples various system components including the system memory to the processing unit 1820. The system bus 1821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 1810 typically includes a variety of computer readable media. Computer readable media can be any available media that can be accessed by computer 1810 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other one or more media which may be used to store the desired information and may be accessed by computer 1810. Communication media typically embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared and other wireless media. Combinations of the any of the above should also be included within the scope of computer readable media.

The system memory 1830 includes computer storage media in the form of volatile and/or nonvolatile memory such as read only memory (ROM) 1831 and random access memory (RAM) 1832. A basic input/output system 1833 (BIOS), containing the basic routines that help to transfer information between elements within computer 1810, such as during start-up, is typically stored in ROM 1831. RAM 1832 typically contains data and/or program modules that are immediately accessible to and/or presently being operated on by processing unit 1820. By way of example, and not limitation, FIG. 18 illustrates operating system 1834, application programs 1835, other program modules 1836, and program data 1837.

The computer 1810 may also include other removable/non-removable, volatile/nonvolatile computer storage media. By way of example only, FIG. 18 illustrates a hard disk drive 1841 that reads from or writes to non-removable, nonvolatile magnetic media, a magnetic disk drive 1851 that reads from or writes to a removable, nonvolatile magnetic disk 1852, and an optical disk drive 1855 that reads from or writes to a removable, nonvolatile optical disk 1856 such as a CD ROM or other optical media. Other removable/non-removable, volatile/nonvolatile computer storage media that can be used in the exemplary computing system include, but are not limited to, magnetic tape cassettes, flash memory cards, digital versatile disks, digital video tape, solid state RAM, solid state ROM, and the like. The hard disk drive 1841 is typically connected to the system bus 1821 through an non-removable memory interface such as interface 1840, and magnetic disk drive 1851 and optical disk drive 1855 are typically connected to the system bus 1821 by a removable memory interface, such as interface 1850.

The drives and their associated computer storage media discussed above and illustrated in FIG. 18, provide storage of computer readable instructions, data structures, program modules and other data for the computer 1810. In FIG. 18, for example, hard disk drive 1841 is illustrated as storing operating system 1844, application programs 1845, other program modules 1846, and program data 1847. Note that these components can either be the same as or different from operating system 1834, application programs 1835, other program modules 536, and program data 1837. Operating system 1844, application programs 1845, other program modules 1846, and program data 1847 are given different numbers here to illustrate that, at a minimum, they are different copies. A user may enter commands and information into the computer 1810 through input devices such as a keyboard 1862 and pointing device 1861, commonly referred to as a mouse, trackball or touch pad. Other input devices (not shown) may include a microphone, joystick, game pad, satellite dish, scanner, or the like. These and other input devices are often connected to the processing unit 1820 through a user input interface 560 that is coupled to the system bus, but may be connected by other interface and bus structures, such as a parallel port, game port or a universal serial bus (USB). A monitor 1891 or other type of display device is also connected to the system bus 1821 via an interface, such as a video interface 1890. In addition to the monitor, computers may also include other peripheral output devices such as speakers 1897 and printer 1896, which may be connected through a output peripheral interface 1895.

The computer 1810 may operate in a networked environment using logical connections to one or more remote computers, such as a remote computer 1880. The remote computer 1880 may be a personal computer, a server, a router, a network PC, a peer device or other common network node, and typically includes many or all of the elements described above relative to the computer 1810, although only a memory storage device 1881 has been illustrated in FIG. 18. The logical connections depicted in FIG. 18 include a local area network (LAN) 1871 and a wide area network (WAN) 1873, but may also include other networks. Such networking environments are commonplace in offices, enterprise-wide computer networks, intranets and the Internet.

When used in a LAN networking environment, the computer 1810 is connected to the LAN 1871 through a network interface or adapter 1870. When used in a WAN networking environment, the computer 1810 typically includes a modem 1872 or other means for establishing communications over the WAN 1873, such as the Internet. The modem 1872, which may be internal or external, may be connected to the system bus 1821 via the user input interface 1860, or other appropriate mechanism. In a networked environment, program modules depicted relative to the computer 1810, or portions thereof, may be stored in the remote memory storage device. By way of example, and not limitation, FIG. 18 illustrates remote application programs 1885 as residing on memory device 1881. It will be appreciated that the network connections shown are exemplary and other means of establishing a communications link between the computers may be used.

Embodiments of the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a tangible machine, mechanism or device from which a computer may read information. Alternatively or additionally, the invention may be embodied as a computer readable medium other than a computer-readable storage medium. Examples of computer readable media which are not computer readable storage media include transitory media, like propagating signals.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

The invention may be embodied as a method, of which an example has been described. The acts performed as part of the method may be ordered in any suitable way. Accordingly, embodiments may be constructed in which acts are performed in an order different than illustrated, which may include different acts than those which are described, and/or which may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A system, comprising:
a plurality of projector units, each configured to transmit electromagnetic signals;
a plurality of wearable receiving units, each configured to receive electromagnetic signals transmitted by at least one of the plurality of projector units, to process received electromagnetic signals, and to manifest a change in state as a result of the processing the received electromagnetic signals;
a controller unit, for controlling the plurality of projector units to transmit electromagnetic signals to the plurality of wearable receiving units; and
at least one computer processor, programmed to:
access data describing a physical setting in which the plurality of projector units are to transmit electromagnetic signals to the plurality of wearable receiving units;
receive input from a user, the input specifying at least one parameter relating to transmissions of electromagnetic signals by the plurality of projector units to the plurality of wearable receiving units in the physical setting;
generate information defining a visual simulation which, when presented to the user, depicts on a graphical user interface a simulated result of the wearable receiving units processing electromagnetic signals transmitted by the projector units in the physical setting according to the at least one parameter; and
produce control data, using the input received from the user, for use by the controller unit in controlling the plurality of projector units to transmit electromagnetic signals to the plurality of wearable receiving units in the physical setting according to the at least one parameter.

2. The system of claim 1, wherein the at least one computer processor is programmed to access data defining a location of each of the plurality of projector units within the physical setting.

3. The system of claim 1, wherein the at least one computer processor is programmed to receive input relating to at least one of: a position, zoom, or focus of one or more of the plurality of projector units, degradation of an electromagnetic signal transmitted by one or more of the plurality of projector units over distance, an optics component used by one or more of the plurality of projector units, a strength of a transmission by one or more of the plurality of projector units, and a likelihood that an electromagnetic signal reaches one or more of the plurality of wearable receiving units.

4. The system of claim 1, wherein the at least one computer processor is programmed to receive input relating to a plurality of zones within the physical setting and a number of wearable receiving units which are to reside in each of the plurality of zones.

5. The system of claim 1, wherein the at least one computer processor is programmed to:
receive input defining processing to be performed by one or more of the plurality of wearable receiving units upon receipt of at least one electromagnetic signal; and
generate information defining a visual simulation which, when presented, depicts on the graphical user interface the one or more wearable receiving units performing the processing in response to receiving the at least one electromagnetic signal.

6. The system of claim 1, wherein the at least one computer processor is programmed to generate information defining a visual simulation which, when presented, depicts on the graphical user interface a result of processing performed by the plurality of wearable receiving units in response to receiving electromagnetic signals having wavelengths in a non-visible portion of the spectrum.

7. The system of claim 1, wherein the at least one computer processor is programmed to generate information defining a simulation which, when presented, depicts on the graphical user interface visible light being projected by at least one of the projector units toward the wearable receiving units in the physical setting.

8. The system of claim 1, wherein at least one of the plurality of projector units is configured to change position while transmitting electromagnetic signals, thereby transmitting the electromagnetic signals to different wearable receiving units in the physical setting over time, and the at least one computer processor is programmed to receive input defining a manner in which the at least one projector unit is to change position while transmitting electromagnetic signals.

9. A method of defining a manner in which a plurality of projector units are to transmit, in a physical setting, electromagnetic signals to a plurality of wearable receiving units each configured to process at least one received electromagnetic signal and to manifest a change in state as a result of the processing, the method comprising acts of:
(A) at least one computer accessing data describing the physical setting;
(B) the at least one computer receiving input from a user specifying at least one parameter relating to transmissions of electromagnetic signals by the plurality of projector units to the plurality of wearable receiving units in the physical setting;
(C) the at least one computer generating information defining a visual simulation which, when presented to the user, depicts on a graphical user interface a simulated result of the wearable receiving units processing electromagnetic signals transmitted by from the projector units in the physical setting according to the at least one parameter; and
(D) the at least one computer producing control data, using the input received in the act (B), for use by a controller unit in controlling the plurality of projector units to transmit electromagnetic signals to the plurality of wearable receiving units in the physical setting according to the at least one parameter.

10. The method of claim 9, wherein the act (A) comprises accessing data defining a location where each of the plurality of projector units are to reside within the physical setting.

11. The method of claim 9, wherein the act (B) comprises receiving input relating to at least one of: a position, zoom, or focus of one or more of the plurality of projector units, degradation of an electromagnetic signal transmitted by one or more of the plurality of projector units over distance, an optics component used by one or more of the plurality of projector units, a strength of a transmission by one or more of the plurality of projector units, and a likelihood that an electromagnetic signal reaches one or more of the plurality of wearable receiving units.

12. The method of claim 9, wherein the act (B) comprises receiving input specifying a plurality of zones within the physical setting and a number of wearable receiving units which are to reside in each of the plurality of zones.

13. The method of claim 9, wherein the act (B) comprises receiving input defining processing to be performed by one or more of the plurality of wearable receiving units in response to receiving at least one electromagnetic signal, and the act (C) comprises generating information defining a simulation which, when presented, depicts on the graphical user interface the processing performed by the one or more of the plurality of wearable receiving units in response to receiving the at least one electromagnetic signal.

14. The method of claim 9, wherein the act (C) comprises generating information defining a simulation which, when presented, depicts on the graphical user interface a result of processing performed by the plurality of wearable receiving units in response to receiving electromagnetic signals having wavelengths in a non-visible portion of the spectrum.

15. The method of claim 9, wherein the act (C) comprises generating information defining a simulation which, when presented, depicts on the graphical user interface visible light being projected toward the wearable receiving units in the physical setting.

16. The method of claim 9, wherein at least one of the plurality of projector units is configured to change position while transmitting electromagnetic signals, thereby transmitting the electromagnetic signals to different wearable receiving units in the physical setting over time, and the act (B) comprises receiving input defining a manner in which the at least one projector unit is to change position while transmitting electromagnetic signals.

17. At least one computer-readable storage medium having instructions recorded thereon which, when executed by at least one computer, cause the at least one computer to perform a method of defining a manner in which a plurality of projector units are to transmit, in a physical setting, electromagnetic signals to a plurality of wearable receiving units each configured to process at least one received electromagnetic signal and to manifest a change in state as a result of the processing, the method comprising acts of:
(A) accessing data describing the physical setting;
(B) receiving input from a user specifying at least one parameter relating to transmissions of electromagnetic signals by the plurality of projector units to the plurality of wearable receiving units in the physical setting;
(C) generating information defining a visual simulation which, when presented to the user, depicts on a graphical user interface a simulated result of the wearable receiving units processing electromagnetic signals transmitted by from the projector units in the physical setting according to the at least one parameter; and
(D) producing control data, using the input received in the act (B), for use by a controller unit in controlling the plurality of projector units to transmit electromagnetic signals to the plurality of wearable receiving units in the physical setting according to the at least one parameter.
